(19) United States
(12) Patent Application Publication
(10) Pub. No.: US 2018/0236372 A1
(43) Pub. Date: Aug. 23, 2018

(54) PRODUCTION OF MULTIVALENT ION-RICH STREAMS USING HUMIDIFICATION-DEHUMIDIFICATION SYSTEMS

(71) Applicant: Gradiant Corporation, Woburn, MA (US)

(72) Inventors: Prakash Narayan Govindan, Melrose, MA (US); Maximus G. St. John, Boston, MA (US)

(73) Assignee: Gradiant Corporation, Woburn, MA (US)

(21) Appl. No.: 15/752,631

(22) PCT Filed: Aug. 12, 2016
(86) PCT No.: PCT/US2016/046732

§ 371 Date: Feb. 14, 2018

Related U.S. Application Data
(60) Provisional application No. 62/205,640, filed on Aug. 14, 2015.

(51) Int. Cl. B01D 3/14; B01D 61/02; B01D 61/08; B01D 61/04; B01D 61/46; B01D 3/34; B01D 3/16; B01D 5/00; B01D 1/00; C02F 1/04; C02F 9/00; B01D 17/02; C02F 1/44; C02F 1/469; C02F 1/16

(52) U.S. Cl. CPC B01D 3/145; C02F 2103/08; B01D 61/08; B01D 61/04; B01D 61/46; B01D 3/346; B01D 3/16; B01D 5/006; B01D 1/0058; C02F 1/048; C02F 9/00; B01D 17/02; C02F 1/442; C02F 1/4693; B01D 5/003; C02F 1/16; B01D 2311/04; B01D 2311/06; B01D 2311/2673; B01D 61/027

(57) ABSTRACT

Disclosed herein are systems and methods in which an aqueous stream comprising solubilized monovalent ions and solubilized multivalent ions is processed such that multivalent ions are selectively retained and monovalent ions are selectively removed. According to certain embodiments, an aqueous feed stream is transported through an ion-selective separator to produce a multivalent-ion-enriched stream and a monovalent-ion-enriched stream. The monovalent-ion-enriched stream may be transported through a desalination apparatus to produce a substantially pure water stream and a concentrated aqueous stream. In some embodiments, at least a portion of the multivalent-ion-enriched stream produced by the ion-selective separator is combined with at least a portion of the substantially pure water stream produced by the desalination apparatus to produce a combined product stream containing a relatively large percentage of the solubilized multivalent ions from the aqueous feed stream and a relatively small percentage of the solubilized monovalent ions from the aqueous feed stream.

### RELATED APPLICATIONS

This application claims priority under 35 U.S.C. § 119(e) to U.S. Provisional Patent Application Ser. No. 62/205,640, filed Aug. 14, 2015 and entitled “Production of Multivalent Ion-Rich Streams Using Humidification-Dehumidification Systems,” which is incorporated herein by reference in its entirety for all purposes.

### TECHNICAL FIELD

Systems and methods in which solubilized multivalent ions are selectively retained in an aqueous stream are generally described.

### BACKGROUND

As worldwide demand for energy continues to increase, oil has become one of the most valuable natural resources in the world. In order to satisfy the demand for oil, various methods have been used to enhance recovery of oil from oil reservoirs. For example, one method is waterflooding, which involves injection of water into an oil reservoir to displace oil from porous rocks in the reservoir. However, some amount of oil may remain in the reservoir after using conventional waterflooding methods. Accordingly, improved methods and systems are desired.

### SUMMARY

Selective retention of solubilized multivalent ions in aqueous streams is generally described. Certain embodiments are related to inventive systems comprising an ion-selective separator and a desalination apparatus. The subject matter of the present invention involves, in some cases, interrelated products, alternative solutions to a particular problem, and/or a plurality of different uses of one or more systems and/or articles.

Certain embodiments relate to methods. In some embodiments, a method comprises transporting an aqueous feed stream containing solubilized monovalent ions and solubilized multivalent ions into an ion-selective separator comprising an ion-selective membrane to produce a first permeate stream containing at least about 75% of the solubilized monovalent ions from the aqueous feed stream and a first retentate stream containing at least about 75% of the solubilized multivalent ions from the aqueous feed stream. In certain embodiments, the method further comprises transporting at least a portion of the first permeate stream to a desalination apparatus comprising a humidifier and a dehumidifier. In certain embodiments, the method further comprises allowing at least a portion of the first permeate stream to evaporate within a humidifier of the desalination apparatus to produce a humidified gas and a concentrated aqueous stream having a higher concentration of solubilized monovalent ions than the first permeate stream. In some embodiments, the method further comprises condensing at least a portion of the water within the humidified gas within the dehumidifier to produce a condensed aqueous stream. In some embodiments, the method further comprises mixing at least a portion of the condensed aqueous stream with at least a portion of the first retentate stream to form a combined product stream.

Some embodiments are directed to systems. In some embodiments, a system comprises an ion-selective separator comprising an ion-selective membrane, the separator comprising a retentate side and a permeate side. In some embodiments, the system further comprises a humidification-dehumidification desalination apparatus. In certain embodiments, the desalination apparatus is fluidically connected to the permeate side of the ion-selective separator. In certain embodiments, the desalination apparatus is fluidically connected to the retentate side of the ion-selective separator.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of an exemplary system comprising an ion-selective separator and a humidification-dehumidification (HDH) desalination apparatus, according to some embodiments;

FIG. 2A is, according to some embodiments, a schematic illustration of an exemplary system comprising an ion-selective membrane separator and an HDH desalination apparatus, where the HDH desalination apparatus comprises a humidifier and a dehumidifier housed in a single vessel;

FIG. 2B is, according to some embodiments, a schematic illustration of an exemplary system comprising an ion-selective membrane separator and an HDH desalination apparatus, where the HDH desalination apparatus comprises a humidifier and a dehumidifier housed in separate vessels;

FIG. 3 is a schematic illustration of an exemplary system comprising an ion-selective separator, an HDH desalination apparatus, and a generator, according to some embodiments; and

FIG. 4 is, according to some embodiments, a schematic diagram of an exemplary system comprising a water-immiscible phase separator, an ion-selective separator, and an HDH desalination apparatus.

### DETAILED DESCRIPTION

Disclosed herein are systems and methods in which an aqueous stream comprising solubilized monovalent ions and solubilized multivalent ions is processed such that solubilized multivalent ions are selectively retained and solubilized monovalent ions are selectively removed. According to certain embodiments, an aqueous feed stream comprising solubilized monovalent ions and solubilized multivalent ions may be transported through an ion-selective separator to produce a multivalent-ion-enriched stream and a monovalent-ion-enriched stream. The monovalent-ion-enriched stream may be transported through a humidification-dehumidification (HDH) desalination apparatus to produce a substantially pure water stream and a concentrated aqueous stream. In some embodiments, at least a portion of the multivalent-ion-enriched stream produced by the ion-selective separator is combined with at least a portion of the substantially pure water stream produced by the HDH desalination apparatus to produce a combined product stream containing a relatively large percentage of the solubilized multivalent ions from the aqueous feed stream and a relatively small percentage of the solubilized monovalent ions from the aqueous feed stream.

One method of extracting oil from oil reservoirs is waterflooding, which involves injecting a stream of water into an oil reservoir to displace oil from the pores of porous rocks in the reservoir. It has been recognized that injecting a stream of water having a relatively high concentration of solubilized multivalent ions (e.g., divalent ions) and a relatively low concentration of solubilized monovalent ions may advantageously enhance recovery of oil from an oil reservoir, resulting in displacement of oil that would not otherwise have been displaced by injection of other water streams. Accordingly, it may be desirable to produce aqueous streams having a relatively high concentration of solubilized multivalent ions and a relatively low concentration of solubilized monovalent ions.

Some embodiments described herein are related to inventive systems comprising an ion-selective separator fluidically connected to an HDH desalination apparatus. In certain cases, such embodiments may be capable of producing aqueous streams that are enriched in solubilized multivalent ions and diminished in solubilized monovalent ions relative to an aqueous feed stream comprising a mixture of solubilized multivalent ions and solubilized monovalent ions. In addition, in certain embodiments, such inventive systems may be associated with certain advantages, such as increased efficiency and/or ability to produce other desirable products (e.g., high-density concentrated aqueous streams). For example, in some embodiments, the system may comprise a generator that supplies electrical power to the ion-selective separator and/or the HDH desalination apparatus. The generator may also, in some embodiments, generate a substantial amount of heat. Instead of discarding the heat produced by the generator as waste heat, resulting in a significant loss of energy, the heat may instead be transferred to the HDH desalination apparatus to facilitate desalination. Accordingly, certain embodiments may enhance efficiency and/or require relatively low amounts of energy.

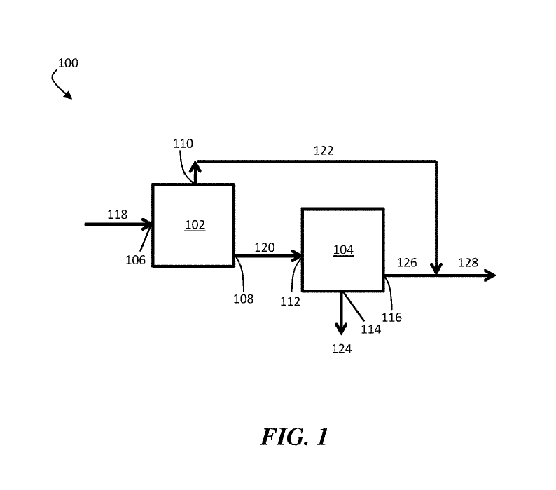

In some embodiments, a system for producing an aqueous stream enriched in solubilized multivalent ions and diminished in solubilized monovalent ions comprises an ion-selective separator configured to receive an aqueous feed stream comprising solubilized multivalent ions and solubilized monovalent ions and to at least partially separate the solubilized multivalent ions from the solubilized monovalent ions. For example, FIG. 1 shows an exemplary schematic illustration of a system comprising an ion-selective separator and an HDH desalination apparatus. Referring to FIG. 1, system 100 comprises ion-selective separator 102 fluidically connected to HDH desalination apparatus 104. The ion-selective separator comprises, according to certain embodiments, an inlet configured to receive an aqueous feed stream containing solubilized multivalent ions and solubilized monovalent ions. In FIG. 1, ion-selective separator 102 comprises inlet 106 configured to receive aqueous feed stream 118. In some embodiments, the ion-selective separator further comprises a first outlet configured to output a monovalent-ion-enriched stream and a second outlet configured to output a multivalent-ion-enriched stream. For example, referring to FIG. 1, ion-selective separator 102 comprises first outlet 108 configured to output monovalent-ion-enriched stream 120 and second outlet 110 configured to output multivalent-ion-enriched stream 122.

In some embodiments, operation of the ion-selective separator comprises transporting an aqueous feed stream containing solubilized monovalent ions and solubilized multivalent ions into the ion-selective separator to at least partially separate the solubilized monovalent ions and the solubilized multivalent ions to produce a monovalent-ion-enriched stream and a multivalent-ion-enriched stream. For example, referring to FIG. 1, in some embodiments, aqueous feed stream 118 containing solubilized monovalent ions and solubilized multivalent ions is transported into ion-selective separator 102 to at least partially separate the solubilized monovalent ions and the solubilized multivalent ions to produce monovalent-ion-enriched stream 120 and multivalent-ion-enriched stream 122.

In some embodiments, a relatively large percentage of the solubilized multivalent ions from the aqueous feed stream is present in the multivalent-ion-enriched stream. For example, in certain embodiments, the multivalent-ion-enriched stream contains at least about 75% (or at least about 85%, at least about 90%, at least about 95%, or at least about 99%, on a molar basis) of the solubilized multivalent ions from the aqueous feed stream. In some embodiments, the percentage of solubilized multivalent ions from the aqueous feed stream that is present in the multivalent-ion-enriched stream is in the range of about 75% to about 85%, about 75% to about 90%, about 75% to about 95%, about 75% to about 99%, about 75% to about 100%, about 85% to about 90%, about 85% to about 95%, about 85% to about 99%, about 85% to about 100%, about 90% to about 95%, about 90% to about 99%, about 90% to about 100%, about 95% to about 99%, or about 95% to about 100%. Referring to FIG. 1, multivalent-ion-enriched stream 122 can contain at least about 75% (or at least about 85%, at least about 90%, at least about 95%, or at least about 99%, on a molar basis) of the solubilized multivalent ions from aqueous feed stream 118.

In some embodiments, a relatively large percentage of the solubilized monovalent ions from the aqueous feed stream is present in the monovalent-ion-enriched stream. According to certain embodiments, the monovalent-ion-enriched stream contains at least about 75% (or at least about 85%, at least about 90%, at least about 95%, or at least about 99%, on a molar basis) of the solubilized monovalent ions from the aqueous feed stream. In some embodiments, the percentage of solubilized monovalent ions from the aqueous feed stream that is present in the monovalent-ion-enriched stream is in the range of about 75% to about 85%, about 75% to about 90%, about 75% to about 95%, about 75% to about 99%, about 75% to about 100%, about 85% to about 90%, about 85% to about 95%, about 85% to about 99%, about 85% to about 100%, about 90% to about 95%, about 90% to about 99%, about 90% to about 100%, about 95% to about 99%, or about 95% to about 100%. For example, in FIG. 1, monovalent-ion-enriched stream 120 can contain at least about 75% (or at least about 85%, at least about 90%, at least about 95%, or at least about 99%, on a molar basis) of the solubilized monovalent ions from aqueous feed stream 118.

In some embodiments, the monovalent-ion-enriched stream contains substantially more solubilized monovalent ions than solubilized multivalent ions. In certain embodiments, the ratio of solubilized monovalent ions to solubilized multivalent ions within the monovalent-ion-enriched stream is at least about 3:1, at least about 5:1, at least about 10:1, at least about 20:1, at least about 50:1, at least about 100:1, at least about 200:1, at least about 500:1, at least about 1,000:1, at least about 2,000:1, at least about 5,000:1, at least about 10,000:1, or more. In some embodiments, the ratio of solubilized monovalent ions to solubilized multivalent ions within the monovalent-ion-enriched stream is in the range of about 3:1 to about 10:1, about 3:1 to about 50:1, about 3:1 to about 100:1, about 3:1 to about 500:1, about 3:1 to about 1,000:1, about 3:1 to about 5,000:1, about 3:1 to about 10,000:1, about 10:1 to about 100:1, about 10:1 to about 500:1, about 10:1 to about 1,000:1, about 10:1 to about 5,000:1, about 10:1 to about 10,000:1, about 100:1 to about 500:1, about 100:1 to about 1,000:1, about 100:1 to about 5,000:1, about 100:1 to about 10,000:1, about 1,000:1 to about 5,000:1, or about 1,000:1 to about 10,000:1. Referring to FIG. 1, the ratio of solubilized monovalent ions to solubilized multivalent ions within monovalent-ion-enriched stream 120 may be at least about 3:1, at least about 5:1, at least about 10:1, at least about 20:1, at least about 50:1, at least about 100:1, at least about 200:1, at least about 500:1, at least about 1,000:1, at least about 2,000:1, at least about 5,000:1, at least about 10,000:1, or more.

In some embodiments, the monovalent-ion-enriched stream produced by the ion-selective separator is transported to an HDH desalination apparatus. In FIG. 1, for example, monovalent-ion-enriched stream 120 exits ion-selective separator 102 through outlet 108 and enters HDH desalination apparatus 104 through inlet 112. In the HDH desalination apparatus, monovalent ions and water within the monovalent-ion-enriched stream may be separated to produce a concentrated aqueous stream having a higher concentration of monovalent ions than the monovalent-ion-enriched stream and a substantially pure water stream having a lower concentration of monovalent ions than the monovalent-ion-enriched stream. Referring to FIG. 1, for example, HDH desalination apparatus 104 may produce concentrated aqueous stream 124, which may exit HDH desalination apparatus 104 through outlet 114. In some embodiments, the concentrated aqueous stream contains at least about 75% (or at least about 85%, at least about 90%, at least about 95%, or at least about 99%, on a molar basis) of the solubilized monovalent ions from the monovalent-ion-enriched stream and/or the aqueous feed stream. In some embodiments, the percentage of solubilized monovalent ions from the monovalent-ion-enriched stream and/or the aqueous feed stream that is present in the concentrated aqueous stream is in the range of about 75% to about 85%, about 75% to about 90%, about 75% to about 95%, about 75% to about 99%, about 75% to about 100%, about 85% to about 90%, about 85% to about 95%, about 85% to about 99%, about 85% to about 100%, about 90% to about 95%, about 90% to about 99%, about 90% to about 100%, about 95% to about 99%, or about 95% to about 100%. For example, concentrated aqueous stream 124 may contain at least about 75% (or at least about 85%, at least about 90%, at least about 95%, or at least about 99%, on a molar basis) of the solubilized monovalent ions from monovalent-ion-enriched stream 120 and/or aqueous feed stream 118. In addition, HDH desalination apparatus 104 may produce substantially pure water stream 126, which may exit HDH desalination apparatus 104 through outlet 116. In some embodiments, the substantially pure water stream contains about 25% or less (or about 20% or less, about 15% or less, about 10% or less, about 5% or less, about 2% or less, or about 1% or less, on a molar basis) of the solubilized monovalent ions from the monovalent-ion-enriched stream and/or the aqueous feed stream. In some embodiments, the percentage of solubilized monovalent ions from the monovalent-ion-enriched stream and/or the aqueous feed stream that is present in the substantially pure water stream is in the range of about 0% to about 1%, about 0% to about 2%, about 0% to about 5%, about 0% to about 10%, about 0% to about 15%, about 0% to about 20%, about 0% to about 25%, about 1% to about 2%, about 1% to about 5%, about 1% to about 10%, about 1% to about 15%, about 1% to about 20%, about 1% to about 25%, about 2% to about 5%, about 2% to about 10%, about 2% to about 15%, about 2% to about 20%, about 2% to about 25%, about 5% to about 10%, about 5% to about 15%, about 5% to about 20%, about 5% to about 25%, about 10% to about 15%, about 10% to about 20%, or about 10% to about 25%. For example, referring to FIG. 1, substantially pure water stream 126 may contain about 25% or less (or about 20% or less, about 15% or less, about 10% or less, about 5% or less, about 2% or less, or about 1% or less, on a molar basis) of the solubilized monovalent ions from monovalent-ion-enriched stream 120 and/or aqueous feed stream 118.

According to some embodiments, the multivalent-ion-enriched stream produced by the ion-selective separator may be combined with the substantially pure water stream produced by the HDH desalination apparatus to produce a combined product stream. For example, referring to FIG. 1, multivalent-ion-enriched stream 122 produced by ion-selective separator 102 may be combined with substantially pure water stream 126 produced by HDH desalination apparatus 104 to form combined product stream 128. In some cases, combined product stream 128 has a relatively high concentration of solubilized multivalent ions and a relatively low concentration of solubilized monovalent ions.

In certain embodiments, the combined product stream contains a relatively large percentage of the solubilized multivalent ions from the aqueous feed stream. In some cases, combined product stream 128 contains at least about 75% (or at least about 85%, at least about 90%, at least about 95%, or at least about 99%, on a molar basis) of the solubilized multivalent ions from aqueous feed stream 118. In some embodiments, the percentage of solubilized multivalent ions from the aqueous feed stream that is present in the combined product stream is in the range of about 75% to about 85%, about 75% to about 90%, about 75% to about 95%, about 75% to about 99%, about 75% to about 100%, about 85% to about 90%, about 85% to about 95%, about 85% to about 99%, about 85% to about 100%, about 90% to about 95%, about 90% to about 99%, about 90% to about 100%, about 95% to about 99%, or about 95% to about 100%.

In certain embodiments, the combined product stream contains a relatively small percentage of the solubilized monovalent ions from the aqueous feed stream. In some cases, combined product stream 128 contains about 25% or less (or about 20% or less, about 15% or less, about 10% or less, about 5% or less, about 2% or less, or about 1% or less, on a molar basis) of the solubilized monovalent ions from aqueous feed stream 118. In some embodiments, the percentage of solubilized monovalent ions from the aqueous feed stream that is present in the combined product stream is in the range of about 0% to about 1%, about 0% to about 2%, about 0% to about 5%, about 0% to about 10%, about 0% to about 15%, about 0% to about 20%, about 0% to about 25%, about 1% to about 2%, about 1% to about 5%, about 1% to about 10%, about 1% to about 15%, about 1% to about 20%, about 1% to about 25%, about 2% to about 5%, about 2% to about 10%, about 2% to about 15%, about 2% to about 20%, about 2% to about 25%, about 5% to about 10%, about 5% to about 15%, about 5% to about 20%, about 5% to about 25%, about 10% to about 15%, about 10% to about 20%, or about 10% to about 25%.

The ion-selective separator can comprise any suitable separation apparatus capable of at least partially separating monovalent ions and multivalent ions. According to certain embodiments, the ion-selective separator is an ion-selective membrane separator. The ion-selective membrane separator can comprise an ion-selective membrane. The ion-selective membrane can be configured, according to certain embodiments, such that when a first side of the membrane is exposed to an aqueous solution containing both solubilized monovalent ions and solubilized multivalent ions (and, optionally, a hydraulic pressure is applied to the solution on the first side), at least a portion (e.g., at least about 75%, at least about 85%, at least about 90%, at least about 95%, or at least about 99%, on a molar basis) of the solubilized monovalent ions from the aqueous feed stream are transported through the ion-selective membrane from the first side to a second side. In some such embodiments, at least a portion (e.g., at least about 75%, at least about 85%, at least about 90%, at least about 95%, or at least about 99%, on a molar basis) of the solubilized multivalent ions from the aqueous feed stream are prevented from being transported through the ion-selective membrane, and remain on the first side of the ion-selective membrane. The portion of the aqueous feed stream that remains on the first side of the ion-selective membrane may be referred to as the retentate, and the portion of the aqueous feed stream that is transported through the ion-selective membrane from the first side to the second side may be referred to as the permeate. Operation of the ion-selective membrane separator as described can result in the creation of a multivalent-ion-enriched stream (corresponding to the retentate of the ion-selective membrane separator) and a monovalent-ion-enriched stream (corresponding to the permeate of the ion-selective membrane separator).

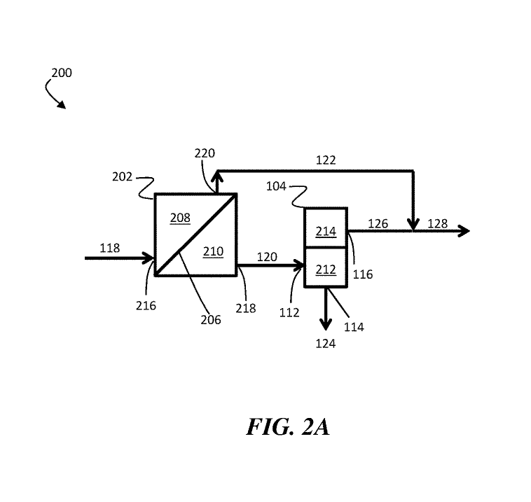

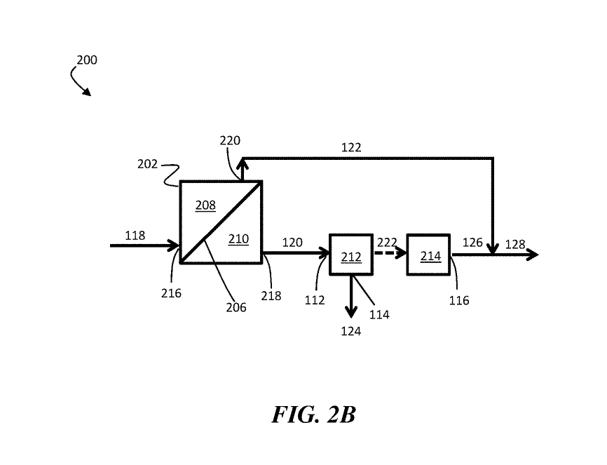

FIGS. 2A-B show exemplary schematic illustrations of system 200, in which the ion-selective separator is an ion-selective membrane separator. As shown in FIGS. 2A-B, ion-selective membrane separator 202 comprises ion-selective membrane 206, which has first side 208 (e.g., the retentate side) and second side 210 (e.g., the permeate side). Certain embodiments comprise transporting an aqueous feed stream containing solubilized monovalent ions and solubilized multivalent ions into the ion-selective membrane separator to at least partially separate the solubilized monovalent ions and the solubilized multivalent ions and to produce a monovalent-ion-enriched stream and a multivalent-ion-enriched stream. For example, referring to FIGS. 2A-B, in some embodiments, aqueous feed stream 118 containing solubilized monovalent ions and solubilized multivalent ions is transported into ion-selective membrane separator 202 to at least partially separate the solubilized monovalent ions and the solubilized multivalent ions to produce monovalent-ion-enriched stream 120 and multivalent-ion-enriched stream 122.

Certain embodiments comprise exposing first side 208 of ion-selective membrane 206 within ion-selective membrane separator 202 to aqueous feed stream 118 (and, optionally, applying a hydraulic pressure to first side 208 of ion-selective membrane 206) such that at least a portion (e.g., at least about 75%, at least about 85%, at least about 90%, at least about 95%, or at least about 99%, on a molar basis) of the solubilized monovalent ions from aqueous feed stream 118 are transported from first side 208 of ion-selective membrane 206, through ion-selective membrane 206, to second side 210 of ion-selective membrane 206. In some such embodiments, at least a portion (e.g., at least about 75%, at least about 85%, at least about 90%, at least about 95%, or at least about 99%, on a molar basis) of the solubilized multivalent ions from aqueous feed stream 118 are prevented from being transported through ion-selective membrane 206, and remain on first side 208 of ion-selective membrane 206. The first side of the ion-selective membrane may be referred to as the retentate side, and the second side of the ion-selective membrane may be referred to as the permeate side. Operation in this manner can result in the creation of multivalent-ion-enriched stream 122 (corresponding to the retentate of ion-selective membrane separator 202) and monovalent-ion-enriched stream 120 (corresponding to the permeate of ion-selective membrane separator 202). The monovalent-ion-enriched stream may, according to certain embodiments, be transported to the desalination apparatus, as described elsewhere herein.

A variety of types of ion-selective membranes may be used, according to certain embodiments. Generally, the ion-selective membrane is chosen such that it may transmit solubilized monovalent ions while inhibiting (or completely preventing) the transmission of solubilized multivalent ions. Such selective separation may be achieved, for example, by using a membrane having appropriately sized pores (e.g., pores with sizes that allow for transmission of solubilized monovalent ions and retention of solubilized multivalent ions). Achieving appropriate separation may also involve, according to certain embodiments, establishing appropriate stream flow rate(s) and/or applying an appropriate hydraulic pressure to the retentate side of the ion-selective membrane. In some embodiments, the ion-selective membrane is made of a bulk material (e.g., a polymer such as polyethylene terephthalate, polysulfone, polyethersulfone; a metal such as aluminum, oxides such as alumina, and composites of these) through which pores extend. The ion-selective membrane may have, according to certain embodiments, an average pore size of at least about 1 nanometer, such as from about 1 nanometer to about 10 nanometers. According to certain embodiments, the ion-selective membrane has a molecular weight cut off of at least about 200 Da, such as from about 200 Da to about 1000 Da, from about 200 Da to about 800 Da, or from about 200 Da to about 400 Da. The molecular weight cutoff of a membrane can be measured, for example, by determining the lowest molecular weight of polyethylene glycol (PEG) or polyethylene oxide (PEO) at which rejection of the PEG or PEO with that molecular weight is greater than 90%, when present at a feed concentration of 200 ppm, a feed pressure of 15 psi, and a feed temperature of 20° C. The ion-selective membrane may have, according to certain embodiments, an average pore size of at least about 1 nanometer, such as from about 1 nanometer to about 10 nanometers. While the ion-selective membranes are generally illustrated as being planar in the figures, it should be understood that the membranes need not necessarily be planar. For example, in some embodiments, the ion-selective membrane(s) can be a spiral-wound membrane or have any other suitable form factor. In some embodiments, the ion-selective membrane (e.g., of the ion-selective separator) comprises a nanofiltration membrane. Examples of commercially available membranes that can be used as an ion-selective membrane include, according to certain embodiments, Dow Filmtec NF-90, GE Osmonics DK series, and Synder NFW membranes.

While the use of ion-selective membrane separators may provide advantages according to certain, but not necessarily all, embodiments, the invention is not limited to the use of such separators, and in other embodiments, other ion-selective separators can be used. For example, in some embodiments, the ion-selective separator comprises an electrodialysis separator. Operation of the electrodialysis separator generally involves the transportation of salt ions from one solution through ion-exchange membranes to another solution under the influence of an applied electric potential difference. In certain embodiments, solubilized monovalent ions and solubilized multivalent ions can be transported at different rates, allowing for at least partial separation of the solubilized monovalent ions and the solubilized multivalent ions. An example of a commercially available electrodialysis separator that can be used, according to certain embodiments, is a 2020EDR system, manufactured by GE.

Certain embodiments are related to systems comprising an ion-selective separator fluidically connected to an HDH desalination apparatus. In some such embodiments, the HDH desalination apparatus can be configured to receive a monovalent-ion-enriched stream produced by the ion-selective separator. In some embodiments, the HDH desalination apparatus can be used to separate at least a portion of the solubilized monovalent ions and the water within the monovalent-ion-enriched stream to produce a concentrated aqueous stream and a substantially purified water stream. According to some embodiments, at least a portion of a multivalent-ion-enriched stream produced by the ion-selective separator can be combined with at least a portion of the substantially purified water stream to form a combined product stream containing a relatively high concentration of solubilized multivalent ions and a relatively low concentration of solubilized monovalent ions. In some embodiments, the combined product stream contains a relatively large percentage of the solubilized multivalent ions from the aqueous feed stream and a relatively small percentage of the solubilized monovalent ions from the aqueous feed stream.

An HDH desalination apparatus generally comprises a humidifier and a dehumidifier. The humidifier may be configured to receive a feed stream comprising water and solubilized monovalent ions and to transfer at least a portion of the water from the feed stream to a carrier gas through an evaporation process, thereby producing a humidified gas stream and a concentrated aqueous stream. The dehumidifier may be configured to receive the humidified gas stream from the humidifier and to transfer at least a portion of the water from the humidified gas stream to a substantially pure water stream through a condensation process, thereby producing a substantially pure water stream.

FIGS. 2A-B show schematic illustrations of exemplary system 200 comprising ion-selective membrane separator 202 and HDH desalination apparatus 104, in which HDH desalination apparatus 104 comprises humidifier 212 and dehumidifier 214. In the exemplary, non-limiting embodiment shown in FIG. 2A, humidifier 212 and dehumidifier 214 are housed within a single vessel. In the exemplary, non-limiting embodiment shown in FIG. 2B, humidifier 212 and dehumidifier 214 are housed in separate vessels.

In operation, monovalent-ion-enriched stream 120 produced by ion-selective membrane separator 202 may exit separator 202 through outlet 218 and enter humidifier 212 of HDH desalination apparatus 104 through inlet 112. In humidifier 212, at least a portion of the water from monovalent-ion-enriched stream 120 may be evaporated to a carrier gas through an evaporation process, producing concentrated aqueous stream 124, which may be discharged from humidifier 212 through outlet 114, and humidified gas stream 222 (not shown in FIG. 2A). Humidified gas stream 222 may flow from humidifier 212 to dehumidifier 214. In dehumidifier 214, at least a portion of the water in humidified gas stream 222 may be condensed to form substantially pure water stream 126, which may be discharged from dehumidifier 214 through outlet 116, and a dehumidified gas stream (not shown in FIGS. 2A-B). In certain cases, at least a portion of the dehumidified gas stream may be directed to flow from dehumidifier 214 to humidifier 212, and/or at least a portion of the dehumidified gas stream may be discharged from system 200 (e.g., released into the environment).

In some embodiments, at least a portion of multivalent-ion-enriched stream 220 produced by ion-selective membrane separator 202 may be combined with substantially pure water stream 126 to form combined product stream 128. Combined product stream 128 may contain a relatively large percentage of the solubilized multivalent ions present in aqueous feed stream 118 and a relatively small percentage of the solubilized monovalent ions present in aqueous feed stream 118.

The humidifier of the HDH desalination apparatus may have any configuration that allows for the transfer of water vapor from an aqueous stream (e.g., a monovalent-ion-enriched stream produced by an ion-selective separator) to a carrier gas through an evaporation process. In some embodiments, the humidifier comprises a liquid inlet configured to receive the aqueous stream and/or a gas inlet configured to receive the carrier gas. The humidifier may further comprise a liquid outlet and/or a gas outlet. In certain embodiments, the carrier gas comprises a non-condensable gas. Non-limiting examples of suitable non-condensable gases include air, nitrogen, oxygen, helium, argon, carbon monoxide, carbon dioxide, sulfur oxides (SOₓ) (e.g., SO₂, SO₃), and/or nitrogen oxides (NOₓ) (e.g., NO, NO₂).

According to some embodiments, the humidifier is a bubble column humidifier (e.g., a humidifier in which the evaporation process occurs through direct contact between an aqueous stream and bubbles of a carrier gas). As discussed in further detail below, a bubble column humidifier may be associated with certain advantages. In some embodiments, the humidifier is a packed bed humidifier (e.g., a humidifier comprising packing material). The packing material may, in some cases, facilitate turbulent gas flow and/or enhance contact between an aqueous stream flowing in a first direction through the packing material and a carrier gas flowing in a second, substantially opposite direction. A non-limiting example of suitable packing material is polyvinyl chloride (PVC) packing material. In certain cases, the humidifier is a spray tower (e.g., a humidifier configured to spray droplets of an aqueous stream). For example, a nozzle or other spraying device may be positioned at the top of the humidifier such that the aqueous stream is sprayed downward towards the bottom of the humidifier. The use of a spraying device may advantageously increase the degree of contact between an aqueous stream fed to the humidifier and a carrier gas into which water from the aqueous stream is transported. The humidifier may, in some embodiments, be a packed bed humidifier and a spray tower (e.g., the spray tower may comprise packing material). In some embodiments, the humidifier is a wetted wall tower (e.g., a humidifier in which the evaporation process occurs through direct contact between a fluid film or laminar layer and a carrier gas).

In some embodiments, the humidifier is configured to be a counter-flow device. For example, in certain cases, the humidifier is configured such that a liquid inlet is positioned at a first end (e.g., a top end) of the humidifier and a gas inlet is positioned at a second, opposite end (e.g., a bottom end) of the humidifier. Such a configuration may facilitate the flow of a liquid stream in a first direction (e.g., downwards) through the humidifier and the flow of a gas stream in a second, substantially opposite direction (e.g., upwards) through the humidifier, which may advantageously result in high thermal efficiency.

The dehumidifier of the HDH desalination apparatus may have any configuration that allows for the transfer of water from a humidified gas stream produced by a humidifier to a substantially pure water stream through a condensation process. In some embodiments, the dehumidifier comprises a gas inlet configured to receive the humidified gas stream from the humidifier and/or a liquid inlet configured to receive a substantially pure water stream (e.g., from a source of substantially pure water). The dehumidifier may further comprise a liquid outlet and/or a gas outlet.

In certain embodiments, the dehumidifier is a bubble column dehumidifier (e.g., a dehumidifier in which the condensation process occurs through direct contact between a substantially pure water stream and bubbles of a humidified gas). In certain cases, the dehumidifier is a surface condenser (e.g., a dehumidifier in which the condensation process occurs through direct contact between a humidified gas and a cooled surface). Non-limiting examples of suitable surface condensers include a cooling tube condenser and a plate condenser.

In some embodiments, the dehumidifier is configured to be a counter-flow device. For example, in certain cases, the dehumidifier is configured such that a liquid inlet is positioned at a first end (e.g., a top end) of the dehumidifier and a gas inlet is positioned at a second, opposite end (e.g., a bottom end) of the dehumidifier. Such a configuration may facilitate the flow of a liquid stream in a first direction (e.g., downwards) through the dehumidifier and the flow of a gas stream in a second, substantially opposite direction (e.g., upwards) through the dehumidifier, which may advantageously result in high thermal efficiency.

According to some embodiments, the humidifier is a bubble column humidifier, and/or the dehumidifier is a bubble column dehumidifier. In some cases, bubble column humidifiers and bubble column dehumidifiers may be associated with certain advantages. For example, bubble column humidifiers and dehumidifiers may exhibit higher thermodynamic effectiveness than certain other types of humidifiers and dehumidifiers. Without wishing to be bound by a particular theory, the increased thermodynamic effectiveness may be at least partially attributed to the use of gas bubbles for heat and mass transfer in bubble column humidifiers and dehumidifiers, since gas bubbles may have more surface area available for heat and mass transfer than many other types of surfaces (e.g., metallic tubes, liquid films, packing material). In addition, bubble column humidifiers and dehumidifiers may have certain features that further increase thermodynamic effectiveness, including, but not limited to, relatively low liquid level height, relatively high aspect ratio liquid flow paths, and multi-staged designs.

In certain embodiments, a bubble column humidifier comprises at least one stage comprising a chamber and a liquid layer positioned within a portion of the chamber. The liquid layer may, in some cases, comprise a liquid comprising water and solubilized monovalent ions. The chamber may further comprise a gas distribution region occupying at least a portion of the chamber not occupied by the liquid layer. In addition, the chamber may be in fluid communication with a bubble generator (e.g., a sparger plate). In some embodiments, a carrier gas stream flows through the bubble generator, forming bubbles of the carrier gas. The carrier gas bubbles may then travel through the liquid layer. The liquid layer may be maintained at a temperature higher than the temperature of the gas bubbles, and as the gas bubbles directly contact the liquid layer, heat and/or mass may be transferred from the liquid layer to the gas bubbles. In some cases, at least a portion of water may be transferred to the gas bubbles through an evaporation process. The bubbles of the humidified gas may exit the liquid layer and enter the gas distribution region. The humidified gas may be substantially homogeneously distributed throughout the gas distribution region. The humidified gas may then exit the bubble column humidifier as a humidified gas stream.

In some embodiments, a bubble column dehumidifier comprises at least one stage comprising a chamber and a liquid layer positioned within a portion of the chamber. The liquid layer may, in some cases, comprise substantially pure water. The chamber may further comprise a gas distribution region occupying at least a portion of the chamber not occupied by the liquid layer. In addition, the chamber may be in fluid communication with a bubble generator (e.g., a sparger plate). In some embodiments, the humidified gas stream flows from the humidifier through the bubble generator, forming bubbles of the humidified gas. The bubbles of the humidified gas may then travel through the liquid layer. The liquid layer may be maintained at a temperature lower than the temperature of the humidified gas bubbles, and as the humidified gas bubbles directly contact the liquid layer, heat and/or mass may be transferred from the humidified gas bubbles to the liquid layer via a condensation process.

In some embodiments, the bubble column humidifier and/or bubble column dehumidifier comprise a plurality of stages. For example, the stages may be arranged such that a gas (e.g., a carrier gas, a humidified gas) flows sequentially from a first stage to a second stage. In some cases, the stages may be arranged in a vertical fashion (e.g., a second stage positioned above a first stage) or a horizontal fashion (e.g., a second stage positioned to the right or left of a first stage). In some cases, each stage comprises a liquid layer. In embodiments relating to a humidifier comprising a plurality of stages (e.g., a multi-stage humidifier), the temperature of the liquid layer of the first stage (e.g., the bottommost stage in a vertically arranged bubble column) may be lower than the temperature of the liquid layer of the second stage, which may be lower than the temperature of the liquid layer of the third stage (e.g., the topmost stage in a vertically arranged bubble column). In embodiments relating to a dehumidifier comprising a plurality of stages (e.g., a multi-stage dehumidifier), the temperature of the liquid layer of the first stage may be higher than the temperature of the liquid layer of the second stage, which may be higher than the temperature of the liquid layer of the third stage.

The presence of multiple stages within a bubble column humidifier and/or bubble column dehumidifier may, in some cases, advantageously result in increased humidification and/or dehumidification of a gas. In some cases, the presence of multiple stages may advantageously lead to higher recovery of substantially pure water. For example, the presence of multiple stages may provide numerous locations where the gas may be humidified and/or dehumidified (e.g., treated to recover substantially pure water). That is, the gas may travel through more than one liquid layer in which at least a portion of the gas undergoes humidification (e.g., evaporation) or dehumidification (e.g., condensation). In addition, the presence of multiple stages may increase the difference in temperature between a liquid stream at an inlet and an outlet of a humidifier and/or dehumidifier. This may be advantageous in systems where heat from a liquid stream (e.g., dehumidifier liquid outlet stream) is transferred to a separate stream (e.g., humidifier input stream) within the system. In such cases, the ability to produce a heated dehumidifier liquid outlet stream can increase the energy effectiveness of the system.

Additionally, the presence of multiple stages may enable greater flexibility for fluid flow within an apparatus. For example, extraction and/or injection of fluids (e.g., gas streams) from intermediate humidification and/or dehumidification stages may occur through intermediate exchange conduits. In certain embodiments, a partially humidified gas stream may be extracted from at least one intermediate location in a bubble column humidifier (e.g., not the final humidification stage) and injected into at least one intermediate location in a bubble column dehumidifier (e.g., not the first dehumidification stage). In some cases, intermediate extraction and injection may be thermodynamically advantageous, and the location of extraction and/or injection points may be selected to increase the thermal efficiency of the desalination apparatus. For example, because a gas (e.g., air) may have increased vapor content at higher temperatures than at lower temperatures, and because the heat capacity of a gas with higher vapor content may be higher than the heat capacity of a gas with lower vapor content, less gas may be used in higher temperature areas of the humidifier and/or dehumidifier to better balance the heat capacity rate ratios of the gas (e.g., air) and liquid (e.g., water) streams. Extraction and/or injection at intermediate locations may therefore advantageously allow for manipulation of gas mass flows and for greater heat recovery.

In some embodiments, the humidifier and the dehumidifier of an HDH desalination apparatus may be housed within a single vessel (e.g., any structure capable of housing a liquid and/or a gas). In certain cases, for example, an HDH desalination apparatus may comprise a vessel (e.g., a tank) comprising a humidification region and a dehumidification region. In some cases, a combined HDH apparatus (e.g., an HDH desalination apparatus comprising a single vessel comprising a humidification region and a dehumidification region) may advantageously have fewer components and/or use less material than an HDH apparatus comprising a separate humidifier and dehumidifier. For example, an HDH apparatus comprising a separate humidifier and dehumidifier may require one or more ducts (e.g., to transport gas streams) and/or pipes (e.g., to transport liquid streams) connecting the humidifier and dehumidifier. In certain cases, the ducts and/or pipes may be expensive and/or burdensome to install. In contrast, ducting and/or piping may be reduced or eliminated in a combined HDH apparatus. For example, a combined HDH apparatus may eliminate the need for ducting between a humidifier gas outlet and a dehumidifier gas inlet. To the extent that ducting is still required (e.g., between intermediate gas extraction/injection inlets and outlets), the gas inlets and outlets may be positioned closer together and thus require less ducting than HDH apparatuses comprising separate humidifiers and dehumidifiers. Similarly, a combined HDH apparatus may require less piping (e.g., for transporting liquid streams) since liquid inlets and outlets may be positioned in close proximity to each other. A combined HDH apparatus may also require less space for walkways and/or maintenance points since components may be positioned in close proximity to each other and/or may require less insulating material (e.g., a separate humidifier and dehumidifier may have additional walls to be insulated compared to a combined HDH apparatus). In addition, the humidification and dehumidification regions of a combined HDH apparatus may have structural similarities, which may allow certain parts to be used in both the humidification and dehumidification regions. Reducing the number of unique parts in an HDH apparatus may advantageously reduce the cost of the apparatus and/or simplify the production process.

According to some embodiments, the humidifier and dehumidifier of an HDH desalination apparatus may be housed within separate vessels. For example, the humidifier may be housed within a first vessel, and the dehumidifier may be housed within a second, separate vessel. The humidifier and dehumidifier may be fluidically connected via one or more ducts and/or one or more pipes. In some cases, a separate humidifier and dehumidifier may advantageously permit more flexibility in positioning the humidifier and dehumidifier at a particular site.

The humidifier and/or dehumidifier may be of any size. The size of the humidifier and/or dehumidifier will generally depend upon the number of humidifiers and/or dehumidifiers employed in the system and the total flow rate of the liquid that is to be desalinated. In certain embodiments, the total of the volumes of the humidifiers and/or dehumidifiers can be at least about 1 gallon, at least about 10 gallons, at least about 100 gallons, at least about 500 gallons, at least about 1,000 gallons, at least about 2,000 gallons, at least about 5,000 gallons, at least about 7,000 gallons, at least about 10,000 gallons, at least about 20,000 gallons, at least about 50,000 gallons, or at least about 100,000 gallons (and/or, in some embodiments, up to about 1,000,000 gallons, or more).

In some embodiments, the HDH desalination apparatus comprises one or more HDH desalination units, each desalination unit comprising a humidifier and a dehumidifier. The HDH desalination apparatus may, according to some embodiments, comprise a plurality of HDH desalination units. In some cases, at least two of the plurality of HDH desalination units may be arranged in series and/or in parallel.

Suitable bubble column condensers that may be used as the dehumidifier and/or suitable bubble column humidifiers that may be used as the humidifier in certain systems and methods described herein include those described in U.S. Pat. No. 8,523,985, by Govindan et al., issued Sep. 3, 2013, and entitled “Bubble-Column Vapor Mixture Condenser”; U.S. Pat. No. 8,778,065, by Govindan et al., issued Jul. 15, 2014, and entitled “Humidification-Dehumidification System Including a Bubble-Column Vapor Mixture Condenser”; U.S. Patent Publication No. 2013/0074694, by Govindan et al., filed Sep. 23, 2011, and entitled “Bubble-Column Vapor Mixture Condenser”; U.S. Patent Publication No. 2014/0367871, by Govindan et al., filed Jun. 12, 2013, and entitled “Multi-Stage Bubble Column Humidifier”; U.S. Patent Publication No. 2015/0083577, filed on Sep. 23, 2014, and entitled “Desalination Systems and Associated Methods”; U.S. Patent Publication No. 2015/0129410, filed on Sep. 12, 2014, and entitled “Systems Including a Condensing Apparatus Such as a Bubble Column Condenser”; U.S. patent application Ser. No. 14/718,483, by Govindan et al., filed May 21, 2015, and entitled “Systems Including an Apparatus Comprising both a Humidification Region and a Dehumidification Region”; U.S. patent application Ser. No. 14/718,510, by Govindan et a., filed May 21, 2015, and entitled “Systems Including an Apparatus Comprising both a Humidification Region and a Dehumidification Region with Heat Recovery and/or Intermediate Injection”; U.S. patent application Ser. No. 14/719,239, by Govindan et al., filed May 21, 2015, and entitled “Transiently-Operated Desalination Systems and Associated Methods”; U.S. patent application Ser. No. 14/719,189, by Govindan et al., filed May 21, 2015, and entitled “Transiently-Operated Desalination Systems with Heat Recovery and Associated Methods”; U.S. patent application Ser. No. 14/719,295, by St. John et al., filed May 21, 2015, and entitled “Methods and Systems for Producing Treated Brines”; and U.S. patent application Ser. No. 14/719,299, by St. John et al., and entitled “Methods and Systems for Producing Treated Brines for Desalination,” each of which is incorporated herein by reference in its entirety for all purposes.

In some embodiments, an HDH desalination apparatus further comprises one or more additional devices. For example, in certain embodiments, an HDH desalination apparatus further comprises a heat exchanger fluidically connected to the humidifier and/or the dehumidifier. In certain cases, the heat exchanger advantageously allows energy to be recovered from a liquid stream exiting the dehumidifier (e.g., a substantially pure water stream) and used to pre-heat a feed stream (e.g., a monovalent-ion-enriched stream produced by an ion-selective separator) prior to entry of the feed stream into the humidifier.

Any heat exchanger known in the art may be used. Examples of suitable heat exchangers include, but are not limited to, plate-and-frame heat exchangers, shell-and-tube heat exchangers, tube-and-tube heat exchangers, plate heat exchangers, plate-and-shell heat exchangers, spiral heat exchangers, and the like. In a particular embodiment, the heat exchanger is a plate-and-frame heat exchanger. In certain embodiments, the heat exchanger may be configured such that a first fluid stream and a second fluid stream flow through the heat exchanger. In some cases, the first fluid stream and the second fluid stream may flow in substantially the same direction (e.g., parallel flow), substantially opposite directions (e.g., counter flow), or substantially perpendicular directions (e.g., cross flow). In some cases, more than two fluid streams may flow through the heat exchanger. In an exemplary embodiment, the heat exchanger is a counter-flow plate-and-frame heat exchanger. In some cases, a counter-flow plate-and-frame heat exchanger may advantageously result in a small temperature difference between two fluid streams flowing through the heat exchanger.

In some embodiments, a relatively large amount of heat may be transferred between the streams flowing through a heat exchanger (e.g., a monovalent-ion-enriched stream and a substantially pure water stream). For example, the difference between the temperature of a fluid entering the heat exchanger and the fluid exiting the heat exchanger may be at least about 5° C., at least about 10° C., at least about 15° C., at least about 20° C., at least about 30° C., at least about 40° C., at least about 50° C., at least about 60° C., at least about 70° C., at least about 80° C., at least about 90° C., or at least about 100° C. In some embodiments, the difference between the temperature of a fluid entering the heat exchanger and the fluid exiting the heat exchanger may be in the range of about 5° C. to about 20° C., about 5° C. to about 30° C., about 5° C. to about 50° C., about 5° C. to about 60° C., about 5° C. to about 90° C., about 5° C. to about 100° C., about 10° C. to about 30° C., about 10° C. to about 60° C., about 10° C. to about 90° C., about 10° C. to about 100° C., about 20° C. to about 60° C., about 20° C. to about 90° C., about 20° C. to about 100° C., about 30° C. to about 60° C., about 30° C. to about 90° C., about 30° C. to about 100° C., about 50° C. to about 100° C., about 60° C. to about 90° C., about 60° C. to about 100° C., or about 80° C. to about 100° C.

In certain embodiments, an HDH desalination apparatus further comprises an optional heating device arranged in fluid communication with a humidifier. The optional heating device may be any device capable of transferring heat to a liquid stream. The heating device may be a heat exchanger, a heat collection device (e.g., a device configured to store and/or utilize thermal energy), or an electric heater. In certain cases, the heating device may be arranged such that a feed stream (e.g., a monovalent-ion-enriched stream produced by an ion-selective separator) is heated prior to entering the humidifier. Heating the feed stream may, in some cases, increase the degree to which water is transferred from the feed stream to the carrier gas stream within the humidifier.

In some embodiments, an HDH desalination apparatus further comprises an optional cooling device arranged in fluid communication with a dehumidifier. In certain cases, a substantially pure water stream may be cooled by the cooling device prior to entering the dehumidifier. A cooling device generally refers to any device that is capable of removing heat from a fluid stream (e.g., a liquid stream, a gas stream). The cooling device may be a heat exchanger (e.g., an air-cooled heat exchanger), a dry cooler, a chiller, a radiator, or any other device capable of removing heat from a fluid stream.

The aqueous feed stream fed to the systems described herein can originate from a variety of sources. For example, in certain embodiments, at least a portion of the aqueous feed stream comprises and/or is derived from seawater, ground water, brackish water, and/or the effluent of a chemical process. In the oil and gas industry, one type of aqueous feed stream that may be encountered is produced water (e.g., water that emerges from oil or gas wells along with the oil or gas). Due to the length of time produced water has spent in the ground, and due to high subterranean pressures and temperatures that may increase the solubility of certain salts and minerals, produced water often comprises relatively high concentrations of dissolved salts and minerals. For example, some produced water streams may comprise a supersaturated solution of dissolved strontium sulfate (SrSO₄). Another type of aqueous feed stream that may be encountered in the oil and gas industry is flowback water (e.g., water that is injected as a fracking fluid during hydraulic fracturing operations and subsequently recovered). Flowback water often comprises a variety of constituents used in fracking, including surfactants, proppants, and viscosity reducing agents, but often has a lower salinity than produced water. In some cases, the systems and methods described herein can be used to produce multivalent-ion-enriched streams from aqueous feed streams comprising and/or derived from such process streams.

As noted above, the aqueous feed stream generally contains both solubilized monovalent ions and solubilized multivalent ions. For example, referring to FIG. 1, aqueous feed stream 118 can comprise at least one solubilized monovalent ion species and at least one solubilized multivalent ion species. The solubilized ions(s) may originate, for example, from a salt that has been dissolved in the aqueous stream. A solubilized ion is generally an ion that has been solubilized to such an extent that the ion is no longer ionically bonded to a counter-ion. The aqueous feed stream can comprise any of a number of solubilized ion species, including, but not limited to, Na⁺, K⁺, Mg²⁺, Ca²⁺, Sr²⁺, Ba²⁺, Cl⁻, carbonate anions, bicarbonate anions, sulfate anions, bisulfate anions, and/or dissolved silica.

In some embodiments, the aqueous feed stream comprises at least one solubilized monovalent cation (i.e., a cation with a redox state of +1 when solubilized). Non-limiting examples of monovalent cations include Na⁺, K⁺, Li⁺, Rb⁺, Cs⁺, and Fr⁺. In certain embodiments, the aqueous feed stream comprises at least one solubilized monovalent anion (i.e., an anion having redox state of −1 when solubilized). Non-limiting examples of monovalent anions include Cl⁻, Br⁻, F⁻, and I⁻. In some embodiments, the aqueous feed stream comprises at least one solubilized monovalent cation and at least one solubilized monovalent anion.

In some embodiments, the aqueous feed stream comprises at least one solubilized multivalent ion (i.e., a cation or anion having a redox state with a magnitude greater than one when solubilized). In certain embodiments, the multivalent ion comprises one or more divalent cations (i.e., a cation with a redox state of +2 when solubilized) and/or one or more divalent anions (i.e., an anion with a redox state of −2 when solubilized). Examples of divalent cations include, but are not limited to, Mg²⁺, Ca²⁺, Sr²⁺, and Ba²⁺. Examples of divalent anions include, but are not limited to, sulfate ions. In some embodiments, the aqueous feed stream comprises at least one of Mg²⁺, Ca²⁺, and sulfate anions. Cations and/or anions having other valencies may also be present in the aqueous feed stream, in some embodiments. For example, in certain embodiments, the aqueous feed stream comprises one or more trivalent ions (e.g., a trivalent cation having a redox state of +3 and/or a trivalent anion having a redox state of −3). Non-limiting examples of trivalent ions include iron, aluminum, and boron ions. In some embodiments, the aqueous feed stream comprises a tetravalent ion (e.g., a tetravalent cation having a redox state of +4 or a tetravalent ion having a redox state of −4). Examples of tetravalent anions include, but are not limited to, silicate ions.

According to some embodiments, the initial concentration of one or more solubilized monovalent ions (e.g., Na⁺, Cl⁻) in the aqueous feed stream is relatively high. In some embodiments, the initial concentration of one or more solubilized monovalent ions in the aqueous feed stream is at least about 1,000 mg/L, at least about 5,000 mg/L, at least about 10,000 mg/L, at least about 25,000 mg/L, at least about 50,000 mg/L, at least about 75,000 mg/L, at least about 100,000 mg/L, at least about 125,000 mg/L, at least about 150,000 mg/L, at least about 175,000 mg/L, at least about 200,000 mg/L, at least about 225,000 mg/L, or at least about 262,000 mg/L (and/or, in certain embodiments, up to the solubility limit of the one or more monovalent ions in the aqueous feed stream). In some embodiments, the initial concentration of one or more solubilized monovalent ions in the aqueous feed stream is in the range of about 1,000 mg/L to about 10,000 mg/L, about 1,000 mg/L to about 50,000 mg/L, about 1,000 mg/L to about 100,000 mg/L, about 1,000 mg/L to about 150,000 mg/L, about 1,000 mg/L to about 200,000 mg/L, about 1,000 mg/L to about 262,000 mg/L, about 10,000 mg/L to about 50,000 mg/L, about 10,000 mg/L to about 100,000 mg/L, about 10,000 mg/L to about 150,000 mg/L, about 10,000 mg/L to about 200,000 mg/L, about 10,000 mg/L to about 262,000 mg/L, about 50,000 mg/L to about 100,000 mg/L, about 50,000 mg/L to about 150,000 mg/L, about 50,000 mg/L to about 200,000 mg/L, about 50,000 mg/L to about 262,000 mg/L, about 100,000 mg/L to about 150,000 mg/L, about 100,000 mg/L to about 200,000 mg/L, about 100,000 mg/L to about 262,000 mg/L, about 150,000 mg/L to about 200,000 mg/L, about 150,000 mg/L to about 262,000 mg/L, or about 200,000 mg/L to about 262,000 mg/L. The concentration of one or more solubilized monovalent ions may be measured according to any method known in the art. For example, suitable methods for measuring the concentration of one or more solubilized monovalent ions include inductively coupled plasma (ICP) spectroscopy (e.g., inductively coupled plasma optical emission spectroscopy). As one non-limiting example, an Optima 8300 ICP-OES spectrometer may be used.

In some embodiments, the aqueous feed stream contains one or more solubilized monovalent ions in an amount of at least about 1 wt %, at least about 5 wt %, at least about 10 wt %, at least about 15 wt %, at least about 20 wt %, at least about 21 wt %, at least about 22 wt %, at least about 23 wt %, at least about 24 wt %, at least about 25 wt %, or at least about 26.2 wt % (and/or, in certain embodiments, up to the solubility limit of the one or more solubilized monovalent ions in the aqueous feed stream). In some embodiments, the aqueous feed stream comprises one or more solubilized monovalent ions in an amount in the range of about 1 wt % to about 10 wt %, about 1 wt % to about 20 wt %, about 1 wt % to about 21 wt %, about 1 wt % to about 22 wt %, about 1 wt % to about 23 wt %, about 1 wt % to about 24 wt %, about 1 wt % to about 25 wt %, about 1 wt % to about 26.2 wt %, about 10 wt % to about 20 wt %, about 10 wt % to about 21 wt %, about 10 wt % to about 22 wt %, about 10 wt % to about 23 wt %, about 10 wt % to about 24 wt %, about 10 wt % to about 25 wt %, about 10 wt % to about 26.2 wt %, or about 20 wt % to about 26.2 wt %.

According to some embodiments, the aqueous feed stream has a relatively high total solubilized monovalent ion concentration (e.g., concentration of all solubilized monovalent ions present in the aqueous feed stream). In certain cases, the total solubilized monovalent ion concentration of the aqueous feed stream is at least about 5,000 mg/L, at least about 10,000 mg/L, at least about 25,000 mg/L, at least about 50,000 mg/L, at least about 75,000 mg/L, at least about 100,000 mg/L, at least about 125,000 mg/L, at least about 150,000 mg/L, at least about 175,000 mg/L, at least about 200,000 mg/L, at least about 225,000 mg/L, or at least about 262,000 mg/L (and/or, in certain embodiments, up to the solubility limit of the monovalent ions in the liquid stream). In some embodiments, the total monovalent ion concentration of the aqueous feed stream is in the range of about 5,000 mg/L to about 10,000 mg/L, about 5,000 mg/L to about 25,000 mg/L, about 5,000 mg/L to about 50,000 mg/L, about 5,000 mg/L to about 75,000 mg/L, about 5,000 mg/L to about 100,000 mg/L, about 5,000 mg/L to about 150,000 mg/L, about 5,000 mg/L to about 200,000 mg/L, about 5,000 mg/L to about 262,000 mg/L, about 10,000 mg/L to about 50,000 mg/L, about 10,000 mg/L to about 75,000 mg/L, about 10,000 mg/L to about 100,000 mg/L, about 10,000 mg/L to about 150,000 mg/L, about 10,000 mg/L to about 200,000 mg/L, about 10,000 mg/L to about 262,000 mg/L, about 50,000 mg/L to about 100,000 mg/L, about 50,000 mg/L to about 150,000 mg/L, about 50,000 mg/L to about 200,000 mg/L, about 50,000 mg/L to about 262,000 mg/L, about 100,000 mg/L to about 150,000 mg/L, about 100,000 mg/L to about 200,000 mg/L, or about 100,000 mg/L to about 262,000 mg/L. The total solubilized monovalent ion concentration generally refers to the combined concentrations of all the solubilized monovalent ions present in the aqueous feed stream. As a simple, non-limiting example, in an aqueous stream comprising Na⁺, Cl⁻, Mg²⁺, and SO₄²⁻ ions, the total solubilized monovalent ion concentration would refer to the sum of the concentrations of the Na⁺ and Cl⁻ ions. As noted above, a suitable method for measuring the concentration of solubilized monovalent ions is ICP spectroscopy.

In some embodiments, the aqueous feed stream has a total solubilized monovalent ion concentration of at least about 1 wt %, at least about 5 wt %, at least about 10 wt %, at least about 15 wt %, at least about 20 wt %, at least about 21 wt %, at least about 22 wt %, at least about 23 wt %, at least about 24 wt %, at least about 25 wt %, or at least about 26.2 wt % (and/or, in certain embodiments, up to the solubility limit of the monovalent ions in the aqueous feed stream). In some embodiments, the aqueous feed stream has a total solubilized monovalent ion concentration in the range of about 1 wt % to about 10 wt %, about 1 wt % to about 20 wt %, about 1 wt % to about 21 wt %, about 1 wt % to about 22 wt %, about 1 wt % to about 23 wt %, about 1 wt % to about 24 wt %, about 1 wt % to about 25 wt %, about 1 wt % to about 26.2 wt %, about 10 wt % to about 20 wt %, about 10 wt % to about 21 wt %, about 10 wt % to about 22 wt %, about 10 wt % to about 23 wt %, about 10 wt % to about 24 wt %, about 10 wt % to about 25 wt %, about 10 wt % to about 26.2 wt %, or about 20 wt % to about 26.2 wt %.

According to some embodiments, the initial concentration of one or more solubilized multivalent ions (e.g., Ca²⁺, Me, SO₄²⁻) in the aqueous feed stream is relatively high. In some embodiments, the initial concentration of one or more solubilized multivalent ions in the aqueous feed stream is at least about 100 mg/L, at least about 200 mg/L, at least about 500 mg/L, at least about 1,000 mg/L, at least about 2,000 mg/L, at least about 5,000 mg/L, at least about 10,000 mg/L, at least about 25,000 mg/L, at least about 50,000 mg/L, at least about 75,000 mg/L, or at least about 100,000 mg/L (and/or, in certain embodiments, up to the solubility limit of the one or more multivalent ions in the aqueous feed stream). In some embodiments, the initial concentration of one or more solubilized multivalent ions in the aqueous feed stream is in the range of about 100 mg/L to about 100,000 mg/L, about 1,000 mg/L to about 10,000 mg/L, about 1,000 mg/L to about 50,000 mg/L, about 1,000 mg/L to about 75,000 mg/L, about 1,000 mg/L to about 100,000 mg/L, about 10,000 mg/L to about 50,000 mg/L, about 10,000 mg/L to about 75,000 mg/L, about 10,000 mg/L to about 100,000 mg/L, about 25,000 mg/L to about 75,000 mg/L, about 25,000 mg/L to about 100,000 mg/L, or about 50,000 mg/L to about 100,000 mg/L. The concentration of one or more solubilized multivalent ions may be measured according to any method known in the art. For example, suitable methods for measuring the concentration of one or more solubilized multivalent ions include inductively coupled plasma (ICP) spectroscopy (e.g., inductively coupled plasma optical emission spectroscopy). As one non-limiting example, an Optima 8300 ICP-OES spectrometer may be used.

In some embodiments, the aqueous feed stream contains one or more solubilized multivalent ions in an amount of at least about 1 wt %, at least about 2 wt %, at least about 5 wt %, or at least about 10 wt % (and/or, in certain embodiments, up to the solubility limit of the one or more multivalent ions in the aqueous feed stream). In some embodiments, the aqueous feed stream comprises one or more solubilized multivalent ions in an amount in the range of about 1 wt % to about 5 wt %, about 1 wt % to about 10 wt %, about 2 wt % to about 5 wt %, about 2 wt % to about 10 wt %, or about 5 wt % to about 10 wt %.

According to some embodiments, the aqueous feed stream has a relatively high total solubilized multivalent ion concentration (e.g., concentration of all solubilized multivalent ions present in the aqueous feed stream). In certain cases, the total solubilized multivalent ion concentration of the aqueous feed stream is at least about 1,000 mg/L, at least about 2,000 mg/L, at least about 5,000 mg/L, at least about 10,000 mg/L, at least about 25,000 mg/L, at least about 50,000 mg/L, at least about 75,000 mg/L, or at least about 100,000 mg/L (and/or, in certain embodiments, up to the solubility limit of the multivalent ions in the liquid stream). In some embodiments, the total solubilized multivalent ion concentration of the aqueous feed stream is in the range of about 1,000 mg/L to about 10,000 mg/L, about 1,000 mg/L to about 25,000 mg/L, about 1,000 mg/L to about 50,000 mg/L, about 1,000 mg/L to about 75,000 mg/L, about 1,000 mg/L to about 100,000 mg/L, about 10,000 mg/L to about 50,000 mg/L, about 10,000 mg/L to about 75,000 mg/L, about 10,000 mg/L to about 100,000 mg/L, about 25,000 mg/L to about 75,000 mg/L, about 25,000 mg/L to about 100,000 mg/L, or about 50,000 mg/L to about 100,000 mg/L. The total solubilized multivalent ion concentration generally refers to the combined concentrations of all the solubilized multivalent ions present in the aqueous feed stream. As a simple, non-limiting example, in an aqueous stream comprising Na⁺, Cl⁻, Me, and SO₄²⁻ ions, the total solubilized multivalent ion concentration would refer to the sum of the concentrations of the Mg²⁺ and SO₄²⁻ ions. As noted above, a suitable method for measuring the concentration of solubilized multivalent ions is ICP spectroscopy.

In some embodiments, the aqueous feed stream has a total solubilized multivalent ion concentration of at least about 1 wt %, at least about 5 wt %, at least about 10 wt %, at least about 15 wt %, at least about 20 wt %, at least about 21 wt %, at least about 22 wt %, at least about 23 wt %, at least about 24 wt %, at least about 25 wt %, at least about 26.2 wt % (and/or, in certain embodiments, up to the solubility limit of the multivalent ions in the aqueous feed stream). In some embodiments, the aqueous feed stream has a total solubilized multivalent ion concentration in the range of about 1 wt % to about 10 wt %, about 1 wt % to about 20 wt %, about 1 wt % to about 21 wt %, about 1 wt % to about 22 wt %, about 1 wt % to about 23 wt %, about 1 wt % to about 24 wt %, about 1 wt % to about 25 wt %, about 1 wt % to about 26.2 wt %, about 10 wt % to about 20 wt %, about 10 wt % to about 21 wt %, about 10 wt % to about 22 wt %, about 10 wt % to about 23 wt %, about 10 wt % to about 24 wt %, about 10 wt % to about 25 wt %, about 10 wt % to about 26.2 wt %, or about 20 wt % to about 26.2 wt %.

In some embodiments, the total concentration of solubilized ions in the aqueous feed stream can be relatively high. One advantage associated with certain embodiments described herein is that aqueous feed streams with relatively high solubilized ion concentrations can be desalinated without the use of energy-intensive desalination methods. In certain embodiments, the total concentration of solubilized ions in the aqueous feed stream transported to the ion-selective separator is at least about 60,000 ppm, at least about 80,000 ppm, or at least about 100,000 ppm (and/or, in some embodiments, up to about 500,000 ppm, or more). Aqueous feed streams with solubilized ion concentrations outside these ranges could also be used.

In some embodiments, at least a portion of the HDH desalination apparatus (e.g., a dehumidifier) is configured to produce a stream comprising water of relatively high purity. For example, in some embodiments, the HDH desalination apparatus produces a stream comprising water in an amount of at least about 95 wt %, at least about 99 wt %, at least about 99.9 wt %, or at least about 99.99 wt % (and/or, in certain embodiments, up to about 99.999 wt %, or more). In some embodiments, the percentage volume of an aqueous feed stream that is recovered as fresh water is at least about 40%, at least about 45%, at least about 50%, at least about 55%, at least about 58%, at least about 60%, or at least about 70%.

In some embodiments, the substantially pure water stream has a relatively low concentration of one or more solubilized monovalent ions. In some cases, the concentration of one or more solubilized monovalent ions (Na⁺, Cl⁻) in the substantially pure water stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the concentration of one or more solubilized monovalent ions in the substantially pure water stream is substantially zero (e.g., not detectable). In certain cases, the concentration of one or more solubilized monovalent ions in the substantially pure water stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

In some embodiments, the substantially pure water stream contains one or more solubilized monovalent ions in an amount of about 2 wt % or less, about 1 wt % or less, about 0.5 wt % or less, about 0.2 wt % or less, about 0.1 wt % or less, about 0.05 wt % or less, or about 0.01 wt % or less. In some embodiments, the substantially pure water stream contains one or more solubilized monovalent ions in an amount in the range of about 0.01 wt % to about 2 wt %, about 0.01 wt % to about 1 wt %, about 0.01 wt % to about 0.5 wt %, about 0.01 wt % to about 0.2 wt %, or about 0.01 wt % to about 0.1 wt %.

In some embodiments, the substantially pure water stream has a relatively low total solubilized monovalent ion concentration (e.g., concentration of all solubilized monovalent ions present in the water stream). In some cases, the total solubilized monovalent ion concentration of the substantially pure water stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the total solubilized monovalent ion concentration of the substantially pure water stream is substantially zero (e.g., not detectable). In certain cases, the total solubilized monovalent ion concentration of the substantially pure water stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

In some embodiments, the substantially pure water stream contains a total amount of solubilized monovalent ions in an amount of about 2 wt % or less, about 1 wt % or less, about 0.5 wt % or less, about 0.2 wt % or less, about 0.1 wt % or less, about 0.05 wt % or less, or about 0.01 wt % or less. In some embodiments, the substantially pure water stream contains a total amount of solubilized monovalent ions in an amount in the range of about 0.01 wt % to about 2 wt %, about 0.01 wt % to about 1 wt %, about 0.01 wt % to about 0.5 wt %, about 0.01 wt % to about 0.2 wt %, or about 0.01 wt % to about 0.1 wt %.

In some embodiments, the total solubilized monovalent ion concentration of the substantially pure water stream is substantially less than the total solubilized monovalent ion concentration of the aqueous feed stream received by the system (e.g., the stream transported into the ion-selective separator). In some cases, the total solubilized monovalent ion concentration of the substantially pure water stream is at least about 0.5%, about 1%, about 2%, about 5%, about 10%, about 15%, or about 20% less than the total solubilized monovalent ion concentration of the aqueous feed stream.

In some embodiments, the substantially pure water stream has a relatively low concentration of one or more solubilized multivalent ions (e.g., divalent ions). In some cases, the concentration of one or more solubilized multivalent ions (Ca²⁺, Mg²⁺, SO₄²⁻) in the substantially pure water stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the concentration of one or more solubilized multivalent ions in the substantially pure water stream is substantially zero (e.g., not detectable). In certain cases, the concentration of one or more solubilized multivalent ions in the substantially pure water stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

In some embodiments, the substantially pure water stream contains one or more solubilized multivalent ions in an amount of about 2 wt % or less, about 1 wt % or less, about 0.5 wt % or less, about 0.2 wt % or less, about 0.1 wt % or less, about 0.05 wt % or less, or about 0.01 wt % or less. In some embodiments, the substantially pure water stream contains one or more solubilized multivalent ions in an amount in the range of about 0.01 wt % to about 2 wt %, about 0.01 wt % to about 1 wt %, about 0.01 wt % to about 0.5 wt %, about 0.01 wt % to about 0.2 wt %, or about 0.01 wt % to about 0.1 wt %.

In some embodiments, the substantially pure water stream has a relatively low total solubilized multivalent ion concentration (e.g., concentration of all solubilized multivalent ions present in the water stream). In some cases, the total solubilized multivalent ion concentration of the substantially pure water stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the total solubilized multivalent ion concentration of the substantially pure water stream is substantially zero (e.g., not detectable). In certain cases, the total solubilized multivalent ion concentration of the substantially pure water stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

In some embodiments, the substantially pure water stream contains a total amount of solubilized multivalent ions in an amount of about 2 wt % or less, about 1 wt % or less, about 0.5 wt % or less, about 0.2 wt % or less, about 0.1 wt % or less, about 0.05 wt % or less, or about 0.01 wt % or less. In some embodiments, the substantially pure water stream contains a total amount of solubilized multivalent ions in an amount in the range of about 0.01 wt % to about 2 wt %, about 0.01 wt % to about 1 wt %, about 0.01 wt % to about 0.5 wt %, about 0.01 wt % to about 0.2 wt %, or about 0.01 wt % to about 0.1 wt %.

In some embodiments, the total solubilized multivalent ion concentration of the substantially pure water stream is substantially less than the total solubilized multivalent ion concentration of the aqueous feed stream received by the system (e.g., the stream transported into the ion-selective separator). In some cases, the total solubilized multivalent ion concentration of the substantially pure water stream is at least about 0.5%, about 1%, about 2%, about 5%, about 10%, about 15%, or about 20% less than the total multivalent ion concentration of the aqueous feed stream.

According to some embodiments, at least a portion of the HDH desalination apparatus (e.g., a humidifier) is configured to produce a concentrated aqueous stream (e.g., a stream having a relatively high concentration of solubilized monovalent ions). In certain embodiments, the concentration of one or more solubilized monovalent ions in the concentrated aqueous stream is at least about 1,000 mg/L, at least about 2,000 mg/L, at least about 5,000 mg/L, at least about 10,000 mg/L, at least about 25,000 mg/L, at least about 50,000 mg/L, at least about 75,000 mg/L, at least about 100,000 mg/L, at least about 150,000 mg/L, at least about 200,000 mg/L, or at least about 262,000 mg/L (and/or, in certain embodiments, up to the solubility limit of the one or more monovalent ions in the concentrated aqueous stream). In some embodiments, the concentration of one or more solubilized monovalent ions in the concentrated aqueous stream is in the range of about 1,000 mg/L to about 10,000 mg/L, about 1,000 mg/L to about 25,000 mg/L, about 1,000 mg/L to about 50,000 mg/L, about 1,000 mg/L to about 100,000 mg/L, about 1,000 mg/L to about 150,000 mg/L, about 1,000 mg/L to about 200,000 mg/L, about 1,000 mg/L to about 262,000 mg/L, about 10,000 mg/L to about 50,000 mg/L, about 10,000 mg/L to about 100,000 mg/L, about 10,000 mg/L to about 150,000 mg/L, about 10,000 mg/L to about 200,000 mg/L, about 10,000 mg/L to about 262,000 mg/L, about 25,000 mg/L to about 50,000 mg/L, about 25,000 mg/L to about 100,000 mg/L, about 25,000 mg/L to about 150,000 mg/L, about 25,000 mg/L to about 200,000 mg/L, about 25,000 mg/L to about 262,000 mg/L, about 50,000 mg/L to about 100,000 mg/L, about 50,000 mg/L to about 150,000 mg/L, about 50,000 mg/L to about 200,000 mg/L, about 50,000 mg/L to about 262,000 mg/L, about 100,000 mg/L to about 150,000 mg/L, about 100,000 mg/L to about 200,000 mg/L, or about 100,000 mg/L to about 262,000 mg/L.

In some embodiments, the concentrated aqueous stream contains one or more solubilized monovalent ions in an amount of at least about 1 wt %, at least about 5 wt %, at least about 10 wt %, at least about 15 wt %, at least about 20 wt %, at least about 21 wt %, at least about 22 wt %, at least about 23 wt %, at least about 24 wt %, at least about 25 wt %, at least about 26.2 wt % (and/or, in certain embodiments, up to the solubility limit of the one or more monovalent ions in the concentrated aqueous stream). In some embodiments, the concentrated aqueous stream comprises one or more solubilized monovalent ions in an amount in the range of about 1 wt % to about 10 wt %, about 1 wt % to about 20 wt %, about 1 wt % to about 21 wt %, about 1 wt % to about 22 wt %, about 1 wt % to about 23 wt %, about 1 wt % to about 24 wt %, about 1 wt % to about 25 wt %, about 1 wt % to about 26.2 wt %, about 10 wt % to about 20 wt %, about 10 wt % to about 21 wt %, about 10 wt % to about 22 wt %, about 10 wt % to about 23 wt %, about 10 wt % to about 24 wt %, about 10 wt % to about 25 wt %, about 10 wt % to about 26.2 wt %, or about 20 wt % to about 26.2 wt %.

In some embodiments, the concentration of one or more solubilized monovalent ions in the concentrated aqueous stream is substantially greater than the concentration of the one or more solubilized monovalent ions in the aqueous feed stream received by the system (e.g., the stream transported into the ion-selective separator). In some cases, the concentration of one or more solubilized monovalent ions in the concentrated aqueous stream is at least about 0.5%, about 1%, about 2%, about 5%, about 10%, about 15%, or about 20% greater than the concentration of one or more solubilized monovalent ions in the aqueous feed stream.

In some cases, the concentrated aqueous stream has a relatively high total solubilized monovalent ion concentration. In certain embodiments, the total solubilized monovalent ion concentration of the concentrated aqueous stream is at least about 5,000 mg/L, at least about 10,000 mg/L, at least about 20,000 mg/L, at least about 50,000 mg/L, at least about 75,000 mg/L, at least about 100,000 mg/L, at least about 150,000 mg/L, at least about 200,000 mg/L, or at least about 262,000 mg/L (and/or, in certain embodiments, up to the solubility limit of the monovalent ions in the concentrated aqueous stream). In some embodiments, the total monovalent ion concentration of the concentrated aqueous stream is in the range of about 10,000 mg/L to about 50,000 mg/L, about 10,000 mg/L to about 100,000 mg/L, about 10,000 mg/L to about 150,000 mg/L, about 10,000 mg/L to about 200,000 mg/L, about 10,000 mg/L to about 262,000 mg/L, about 25,000 mg/L to about 50,000 mg/L, about 25,000 mg/L to about 100,000 mg/L, about 25,000 mg/L to about 150,000 mg/L, about 25,000 mg/L to about 200,000 mg/L, about 25,000 mg/L to about 262,000 mg/L, about 50,000 mg/L to about 100,000 mg/L, about 50,000 mg/L to about 150,000 mg/L, about 50,000 mg/L to about 200,000 mg/L, about 50,000 mg/L to about 262,000 mg/L, about 100,000 mg/L to about 150,000 mg/L, about 100,000 mg/L to about 200,000 mg/L, or about 100,000 mg/L to about 262,000 mg/L.

In some embodiments, the concentrated aqueous stream contains solubilized monovalent ions in a total amount of at least about 1 wt %, at least about 5 wt %, at least about 10 wt %, at least about 15 wt %, at least about 20 wt %, at least about 21 wt %, at least about 22 wt %, at least about 23 wt %, at least about 24 wt %, at least about 25 wt %, or at least about 26.2 wt % (and/or, in certain embodiments, up to the solubility limit of monovalent ions in the concentrated aqueous stream). In some embodiments, the concentrated aqueous stream comprises solubilized monovalent ions in a total amount in the range of about 1 wt % to about 10 wt %, about 1 wt % to about 20 wt %, about 1 wt % to about 21 wt %, about 1 wt % to about 22 wt %, about 1 wt % to about 23 wt %, about 1 wt % to about 24 wt %, about 1 wt % to about 25 wt %, about 1 wt % to about 26.2 wt %, about 10 wt % to about 20 wt %, about 10 wt % to about 21 wt %, about 10 wt % to about 22 wt %, about 10 wt % to about 23 wt %, about 10 wt % to about 24 wt %, about 10 wt % to about 25 wt %, about 10 wt % to about 26.2 wt %, or about 20 wt % to about 26.2 wt %.

In some embodiments, the total solubilized monovalent ion concentration of the concentrated aqueous stream is substantially greater than the total solubilized monovalent ion concentration of the aqueous feed stream received by the system (e.g., the stream transported into the ion-selective separator). In some cases, the total solubilized monovalent ion concentration of the concentrated aqueous stream is at least about 0.5%, about 1%, about 2%, about 5%, about 10%, about 15%, or about 20% greater than the total solubilized monovalent ion concentration of the aqueous feed stream.

In some embodiments, the concentrated aqueous stream has a relatively low total solubilized multivalent ion concentration (e.g., concentration of all multivalent ions present in the water stream). In some cases, the total solubilized multivalent ion concentration of the concentrated aqueous stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the total solubilized multivalent ion concentration of the concentrated aqueous stream is substantially zero (e.g., not detectable). In certain cases, the total solubilized multivalent ion concentration of the concentrated aqueous stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

In some embodiments, the concentrated aqueous stream contains a total amount of solubilized multivalent ions in an amount of about 2 wt % or less, about 1 wt % or less, about 0.5 wt % or less, about 0.2 wt % or less, about 0.1 wt % or less, about 0.05 wt % or less, or about 0.01 wt % or less. In some embodiments, the concentrated aqueous stream contains a total amount of solubilized multivalent ions in an amount in the range of about 0.01 wt % to about 2 wt %, about 0.01 wt % to about 1 wt %, about 0.01 wt % to about 0.5 wt %, about 0.01 wt % to about 0.2 wt %, or about 0.01 wt % to about 0.1 wt %.

In some embodiments, the total solubilized multivalent ion concentration of the concentrated aqueous stream is substantially less than the total solubilized multivalent ion concentration of the aqueous feed stream received by the system (e.g., the stream transported into the ion-selective separator). In some cases, the total solubilized multivalent ion concentration of concentrated aqueous stream is at least about 0.5%, about 1%, about 2%, about 5%, about 10%, about 15%, or about 20% less than the total solubilized multivalent ion concentration of the aqueous feed stream.

According to some embodiments, the HDH desalination apparatus may be operated in a substantially continuous steady state or in a transient mode. Under steady-state operation, a desalination apparatus generally produces one or more product streams (e.g., a substantially pure water stream and/or a condensed aqueous stream) substantially continuously. For example, an aqueous stream may be fed to the desalination apparatus, desalinated in the desalination apparatus, and then discharged from the desalination apparatus without being recirculated. Steady-state operation of a desalination apparatus may, in some cases, be associated with certain advantages, such as high efficiency and/or high reliability. Under transient operation, an aqueous stream may be recirculated through at least a portion of a desalination apparatus until a certain condition is met (e.g., until the aqueous stream reaches a certain density). Upon satisfaction of the condition, the aqueous stream may be discharged from the desalination apparatus. In some cases, transient operation of a desalination apparatus may advantageously increase resistance to salt crystal formation and/or result in production of a high-density concentrated aqueous stream (e.g., a stream having a density of at least about 10 pounds/gallon). In certain cases, a high-density concentrated aqueous stream may be used in the oil and gas industry as a kill fluid (e.g., a high-density fluid placed in a wellbore to stop the flow of reservoir fluids) and/or as a drilling fluid (e.g., a fluid that assists in drilling a wellbore). A high-density concentrated aqueous stream may also be used in other applications, such as de-icing roads or producing chemicals, textiles, and/or leather. Because the high-density concentrated aqueous stream may be a valuable product, a transiently-operated desalination apparatus may avoid the need to dispose of liquid waste streams, which may be expensive and/or complicated.

In some embodiments, a high-density concentrated aqueous stream discharged from a transiently-operated desalination apparatus has a density (e.g., measured at about 60° F.) of at least about 9.5 pounds/gallon, at least about 10 pounds/gallon, at least about 10.5 pounds/gallon, at least about 11 pounds/gallon, at least about 11.5 pounds/gallon, at least about 12 pounds/gallon, at least about 13 pounds/gallon, at least about 14 pounds/gallon, or at least about 15 pounds/gallon. In some embodiments, the high-density concentrated aqueous stream (e.g., measured at about 60° F.) has a density in the range of about 9.5 pounds/gallon to about 11 pounds/gallon, about 9.5 pounds/gallon to about 11.5 pounds/gallon, about 9.5 pounds/gallon to about 12 pounds/gallon, about 9.5 pounds/gallon to about 13 pounds/gallon, about 9.5 pounds/gallon to about 14 pounds/gallon, about 9.5 pounds/gallon to about 15 pounds/gallon, about 10 pounds/gallon to about 11 pounds/gallon, about 10 pounds/gallon to about 11.5 pounds/gallon, about 10 pounds/gallon to about 12 pounds/gallon, about 10 pounds/gallon to about 13 pounds/gallon, about 10 pounds/gallon to about 14 pounds/gallon, about 10 pounds/gallon to about 15 pounds/gallon, about 11 pounds/gallon to about 11.5 pounds/gallon, about 11 pounds/gallon to about 12 pounds/gallon, about 11 pounds/gallon to about 13 pounds/gallon, about 11 pounds/gallon to about 14 pounds/gallon, about 11 pounds/gallon to about 15 pounds/gallon, about 11.5 pounds/gallon to about 12 pounds/gallon, about 11.5 pounds/gallon to about 13 pounds/gallon, about 11.5 pounds/gallon to about 14 pounds/gallon, about 11.5 pounds/gallon to about 15 pounds/gallon, about 12 pounds/gallon to about 13 pounds/gallon, about 12 pounds/gallon to about 14 pounds/gallon, about 12 pounds/gallon to about 15 pounds/gallon, about 13 pounds/gallon to about 15 pounds/gallon, or about 14 pounds/gallon to about 15 pounds/gallon. In some cases, the density of the high-density concentrated aqueous stream is measured at a temperature of about 120° F. or less, about 100° F. or less, about 80° F. or less, about 72° F. or less, about 68° F. or less, about 60° F. or less, about 50° F. or less, or about 40° F. or less. In some embodiments, the density of the high-density concentrated aqueous stream is measured at a temperature of at least about 40° F., at least about 50° F., at least about 60° F., at least about 68° F., at least about 72° F., at least about 80° F., at least about 100° F., or at least about 120° F. In some embodiments, the density of the high-density concentrated aqueous stream is measured at a temperature in the range of about 40° F. to about 120° F., about 40° F. to about 100° F., about 40° F. to about 80° F., about 40° F. to about 72° F., about 40° F. to about 68° F., about 40° F. to about 60° F., about 40° F. to about 50° F., about 60° F. to about 120° F., about 60° F. to about 100° F., or about 60° F. to about 80° F.

In some embodiments, the high-density concentrated aqueous stream has a relatively high concentration of one or more solubilized monovalent ions. In certain cases, the concentration of one or more solubilized monovalent ions in the high-density concentrated aqueous stream is at least about 5,000 mg/L, at least about 10,000 mg/L, at least about 25,000 mg/L, at least about 50,000 mg/L, at least about 75,000 mg/L, at least about 100,000 mg/L, at least about 150,000 mg/L, at least about 200,000 mg/L, at least about 250,000 mg/L, at least about 260,000 mg/L, at least about 270,000 mg/L, at least about 280,000 mg/L, or at least about 290,000 mg/L (and/or, in certain embodiments, up to the solubility limit of the one or more monovalent ions in the high-density concentrated aqueous stream). In some embodiments, the concentration of one or more solubilized monovalent ions in the high-density concentrated aqueous stream is in the range of about 5,000 mg/L to about 290,000 mg/L, about 10,000 mg/L to about 50,000 mg/L, about 10,000 mg/L to about 100,000 mg/L, about 10,000 mg/L to about 150,000 mg/L, about 10,000 mg/L to about 200,000 mg/L, about 10,000 mg/L to about 250,000 mg/L, about 10,000 mg/L to about 260,000 mg/L, about 10,000 mg/L to about 270,000 mg/L, about 10,000 mg/L to about 280,000 mg/L, about 10,000 mg/L to about 290,000 mg/L, about 25,000 mg/L to about 50,000 mg/L, about 25,000 mg/L to about 100,000 mg/L, about 25,000 mg/L to about 150,000 mg/L, about 25,000 mg/L to about 200,000 mg/L, about 25,000 mg/L to about 250,000 mg/L, about 25,000 mg/L to about 260,000 mg/L, about 25,000 mg/L to about 270,000 mg/L, about 25,000 mg/L to about 280,000 mg/L, about 25,000 mg/L to about 290,000 mg/L, about 50,000 mg/L to about 100,000 mg/L, about 50,000 mg/L to about 150,000 mg/L, about 50,000 mg/L to about 200,000 mg/L, about 50,000 mg/L to about 250,000 mg/L, about 50,000 mg/L to about 260,000 mg/L, about 50,000 mg/L to about 270,000 mg/L, about 50,000 mg/L to about 280,000 mg/L, about 50,000 mg/L to about 290,000 mg/L, about 100,000 mg/L to about 150,000 mg/L, about 100,000 mg/L to about 200,000 mg/L, about 100,000 mg/L to about 250,000 mg/L, about 100,000 mg/L to about 260,000 mg/L, about 100,000 mg/L to about 270,000 mg/L, about 100,000 mg/L to about 280,000 mg/L, or about 100,000 mg/L to about 290,000 mg/L.

In some embodiments, the high-density concentrated aqueous stream contains one or more solubilized monovalent ions in an amount of at least about 1 wt %, at least about 5 wt %, at least about 10 wt %, at least about 15 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, or at least about 29 wt % (and/or, in certain embodiments, up to the solubility limit of the one or more monovalent ions in the high-density concentrated aqueous stream). In some embodiments, the high-density concentrated aqueous stream comprises one or more solubilized monovalent ions in an amount in the range of about 1 wt % to about 10 wt %, about 1 wt % to about 20 wt %, about 1 wt % to about 21 wt %, about 1 wt % to about 22 wt %, about 1 wt % to about 23 wt %, about 1 wt % to about 24 wt %, about 1 wt % to about 25 wt %, about 1 wt % to about 26 wt %, about 1 wt % to about 27 wt %, about 1 wt % to about 28 wt %, about 1 wt % to about 29 wt %, about 10 wt % to about 20 wt %, about 10 wt % to about 21 wt %, about 10 wt % to about 22 wt %, about 10 wt % to about 23 wt %, about 10 wt % to about 24 wt %, about 10 wt % to about 25 wt %, about 10 wt % to about 26 wt %, about 10 wt % to about 27 wt %, about 10 wt % to about 28 wt %, about 10 wt % to about 29 wt %, about 20 wt % to about 25 wt %, about 20 wt % to about 26 wt %, about 20 wt % to about 27 wt %, about 20 wt % to about 28 wt %, or about 20 wt % to about 29 wt %.

In some embodiments, the concentration of one or more solubilized monovalent ions in the high-density concentrated aqueous stream is substantially greater than the concentration of the one or more solubilized monovalent ions in the aqueous feed stream received by the system. In some cases, the concentration of one or more solubilized monovalent ions in the high-density concentrated aqueous stream is at least about 0.5%, about 1%, about 2%, about 5%, about 10%, about 15%, or about 20% greater than the concentration of the one or more monovalent ions in the aqueous feed stream.

In some embodiments, the total solubilized monovalent ion concentration of the high-density concentrated aqueous stream upon discharge may be relatively high. In certain cases, the total solubilized monovalent ion concentration of the high-density concentrated aqueous stream is at least about 10,000 mg/L, at least about 25,000 mg/L, at least about 50,000 mg/L, at least about 75,000 mg/L, at least about 100,000 mg/L, at least about 150,000 mg/L, at least about 200,000 mg/L, at least about 250,000 mg/L, at least about 260,000 mg/L, at least about 270,000 mg/L, at least about 280,000 mg/L, or at least about 290,000 mg/L (and/or, in certain embodiments, up to the solubility limit of the monovalent ions in the high-density concentrated aqueous stream). In some embodiments, the total solubilized monovalent ion concentration of the high-density concentrated aqueous stream is in the range of about 10,000 mg/L to about 50,000 mg/L, about 10,000 mg/L to about 100,000 mg/L, about 10,000 mg/L to about 150,000 mg/L, about 10,000 mg/L to about 200,000 mg/L, about 10,000 mg/L to about 250,000 mg/L, about 10,000 mg/L to about 260,000 mg/L, about 10,000 mg/L to about 270,000 mg/L, about 10,000 mg/L to about 280,000 mg/L, about 10,000 mg/L to about 290,000 mg/L, about 25,000 mg/L to about 50,000 mg/L, about 25,000 mg/L to about 100,000 mg/L, about 25,000 mg/L to about 150,000 mg/L, about 25,000 mg/L to about 200,000 mg/L, about 25,000 mg/L to about 250,000 mg/L, about 25,000 mg/L to about 260,000 mg/L, about 25,000 mg/L to about 270,000 mg/L, about 25,000 mg/L to about 280,000 mg/L, about 25,000 mg/L to about 290,000 mg/L, about 50,000 mg/L to about 100,000 mg/L, about 50,000 mg/L to about 150,000 mg/L, about 50,000 mg/L to about 200,000 mg/L, about 50,000 mg/L to about 250,000 mg/L, about 50,000 mg/L to about 260,000 mg/L, about 50,000 mg/L to about 270,000 mg/L, about 50,000 mg/L to about 280,000 mg/L, about 50,000 mg/L to about 290,000 mg/L, about 100,000 mg/L to about 150,000 mg/L, about 100,000 mg/L to about 200,000 mg/L, about 100,000 mg/L to about 250,000 mg/L, about 100,000 mg/L to about 260,000 mg/L, about 100,000 mg/L to about 270,000 mg/L, about 100,000 mg/L to about 280,000 mg/L, or about 100,000 mg/L to about 290,000 mg/L.

In some embodiments, the total solubilized monovalent ion concentration of the high-density concentrated aqueous stream is significantly higher than the total solubilized monovalent ion concentration of an aqueous feed stream received by the system. In some cases, the total solubilized monovalent ion concentration of the high-density concentrated aqueous stream is at least about 5%, at least about 6%, at least about 10%, at least about 14%, at least about 15%, at least about 20%, or at least about 25% greater than the total solubilized monovalent ion concentration of the aqueous feed stream.

In some embodiments, the high-density concentrated aqueous stream has a relatively low total solubilized multivalent ion concentration (e.g., concentration of all solubilized multivalent ions present in the aqueous stream). In some cases, the total solubilized multivalent ion concentration of the high-density concentrated aqueous stream is about 1000 mg/L or less, about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the total solubilized multivalent ion concentration of the high-density concentrated aqueous stream is substantially zero (e.g., not detectable). In certain cases, the total solubilized multivalent ion concentration of the high-density concentrated aqueous stream is in the range of about 0 mg/L to about 1000 mg/L, about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

In some embodiments, the high-density concentrated aqueous stream contains a total amount of solubilized multivalent ions in an amount of about 2 wt % or less, about 1 wt % or less, about 0.5 wt % or less, about 0.2 wt % or less, about 0.1 wt % or less, about 0.05 wt % or less, or about 0.01 wt % or less. In some embodiments, the high-density concentrated aqueous stream contains a total amount of solubilized multivalent ions in an amount in the range of about 0.01 wt % to about 2 wt %, about 0.01 wt % to about 1 wt %, about 0.01 wt % to about 0.5 wt %, about 0.01 wt % to about 0.2 wt %, or about 0.01 wt % to about 0.1 wt %.

In some embodiments, the total solubilized multivalent ion concentration of the concentrated aqueous stream is substantially less than the total solubilized multivalent ion concentration of the aqueous feed stream received by the system for producing a multivalent-ion-enriched, monovalent-ion-diminished combined product stream. In some cases, the total solubilized multivalent ion concentration of the high-density concentrated aqueous stream is at least about 0.5%, about 1%, about 2%, about 5%, about 10%, about 15%, or about 20% less than the total solubilized multivalent ion concentration of the aqueous feed stream.

According to some embodiments, a system for producing a multivalent-ion-enriched, monovalent-ion-diminished combined product stream further comprises an optional generator. In some embodiments, the generator is in electrical communication with an ion-selective separator and/or an HDH desalination apparatus of the system. In certain embodiments, the generator is also in thermal communication with the HDH desalination apparatus. The efficiency of a system comprising an ion-selective separator, an HDH desalination apparatus, and a generator may, in some cases, be enhanced by transferring heat produced by the generator to the HDH desalination apparatus instead of discarding the heat as waste heat.

In some embodiments, a generator may supply electrical power to an ion-selective separator and/or a desalination apparatus of a system. However, while producing electrical power, the generator may also produce heat. If the heat is removed from the generator and released to the environment as waste heat, the waste heat may represent a significant energy loss. Further, if the heat is removed from the generator using one or more fans and/or one or more cooling devices (e.g., a device comprising a cooling jacket and a thermal storage fluid), heat removal may require additional energy input and/or additional materials and system components. In some cases, however, heat produced by the generator may instead be recovered and utilized. According to some embodiments, at least a portion of the heat produced by the generator may be transferred to at least a portion of the HDH desalination apparatus. For example, heat from the generator may be transferred to a humidifier of the HDH desalination apparatus to facilitate evaporation of water from a feed stream to a carrier gas.

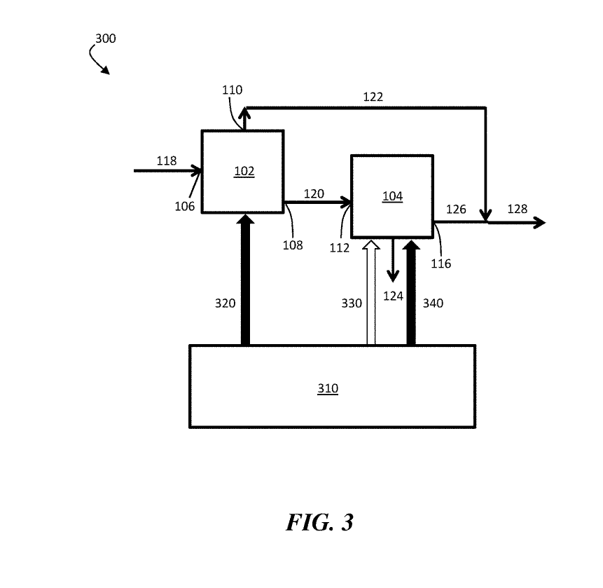

FIG. 3 shows an exemplary schematic illustration of a system 300 comprising ion-selective separator 102, HDH desalination apparatus 104, and generator 310. As shown in FIG. 3, generator 310 is in electrical communication with ion-selective separator 102 (e.g., via electrical wiring). Generator 310 is also in electrical communication and thermal communication with HDH desalination apparatus 104. In operation, electrical power 320 may be transferred from generator 310 to ion-selective separator 102. In addition, thermal power 330 and electrical power 340 may be transferred from generator 310 to HDH desalination apparatus 104.

In some embodiments, the thermal power supplied to the HDH desalination apparatus by the generator may be greater than the electrical power supplied to the desalination apparatus by the generator while the system is in operation. For example, the thermal power supplied to the desalination apparatus may be greater than the electrical power supplied to the desalination apparatus by at least about 1 kilowatt (kW), at least about 5 kW, at least about 10 kW, at least about 20 kW, at least about 50 kW, at least about 100 kW, at least about 200 kW, at least about 500 kW, or at least about 1 megawatt (MW). In some embodiments, the thermal power supplied to the desalination apparatus is greater than the electrical power supplied to the desalination apparatus by an amount in the range of about 1 kW to about 10 kW, about 1 kW to about 20 kW, about 1 kW to about 50 kW, about 1 kW to about 100 kW, about 1 kW to about 200 kW, about 1 kW to about 500 kW, or about 1 kW to about 1 MW.

In some cases, the electrical power supplied to the ion-selective separator by the generator is greater than the electrical power supplied to the HDH desalination apparatus while the system is in operation. For example, the electrical power supplied to the ion-selective separator may be greater than the electrical power supplied to the desalination apparatus by at least about 1 kW, at least about 5 kW, at least about 10 kW, at least about 20 kW, at least about 50 kW, at least about 100 kW, at least about 200 kW, at least about 500 kW, or at least about 1 MW. In some embodiments, the electrical power supplied to the ion-selective separator is greater than the electrical power supplied to the desalination apparatus by an amount in the range of about 1 kW to about 10 kW, about 1 kW to about 20 kW, about 1 kW to about 50 kW, about 1 kW to about 100 kW, about 1 kW to about 200 kW, about 1 kW to about 500 kW, or about 1 kW to about 1 MW.

Any type of generator known in the art may be used. Examples of suitable generators include, but are not limited to, gas-turbine-powered electrical generators and internal combustion electrical generators (e.g., gensets). The generator may be configured to consume a fuel such as natural gas, diesel, propane, kerosene, gasoline, and/or a biofuel. In some embodiments, the generator may be capable of producing at least about 100 kW, at least about 250 kW, at least about 500 kW, at least about 750 kW, at least about 1 MW, at least about 2 MW, at least about 5 MW, or at least about 10 MW of electrical power. In some embodiments, the generator may be capable of producing electrical power in the range of about 100 kW to about 500 kW, about 100 kW to about 1 MW, about 100 kW to about 2 MW, about 100 kW to about 5 MW, about 100 kW to about 10 MW, about 500 kW to about 1 MW, about 500 kW to about 2 MW, about 500 kW to about 5 MW, about 500 kW to about 10 MW, about 1 MW to about 5 MW, about 1 MW to about 10 MW, or about 5 MW to about 10 MW.

In some embodiments, the system may comprise a plurality of generators. The generators of the plurality of the generators may be the same or different types of generators. In some cases, at least two of the plurality of generators may be arranged in series and/or in parallel. In certain cases, at least two of the plurality of generators may be in thermal communication with the desalination apparatus. In certain embodiments, each of the plurality of generators may be in thermal communication with the desalination apparatus.

According to certain embodiments, the aqueous feed stream comprises a suspended and/or emulsified immiscible phase. Generally, a suspended and/or emulsified immiscible phase is a material that is not soluble in water to a level of more than 10% by weight at the temperature and under the conditions at which the water-immiscible phase separator operates. In some embodiments, the suspended and/or emulsified immiscible phase comprises oil and/or grease. The term “oil” generally refers to a fluid that is more hydrophobic than water and is not miscible or soluble in water, as is known in the art. Thus, the oil may be a hydrocarbon in some embodiments, but in other embodiments, the oil may comprise other hydrophobic fluids. In some embodiments, at least about 0.1 wt %, at least about 1 wt %, at least about 2 wt %, at least about 5 wt %, or at least about 10 wt % (and/or, in some embodiments, up to about 20 wt %, up to about 30 wt %, up to about 40 wt %, up to about 50 wt %, or more) of the aqueous feed stream is made up of a suspended and/or emulsified immiscible phase.

It can be undesirable, according to certain embodiments, to allow certain suspended and/or emulsified immiscible phases to enter the system. For example, in certain embodiments in which ion-selective membranes are employed, the membranes can be made of a material (e.g., polysulfones, polyethersulfone) that can be damaged when they are exposed to oil and/or other hydrocarbons. Accordingly, removal of the oil and/or other hydrocarbons upstream of the ion-selective separator can be desirable.

Accordingly, certain embodiments comprise removing at least a portion of a suspended or emulsified immiscible phase from the aqueous feed stream before the aqueous feed stream is transported to an ion-selective separator and/or an ion-selective membrane. In certain embodiments, the system is configured such that little or none of the suspended and/or emulsified immiscible phase is transported to the ion-selective separator and/or an ion-selective membrane.

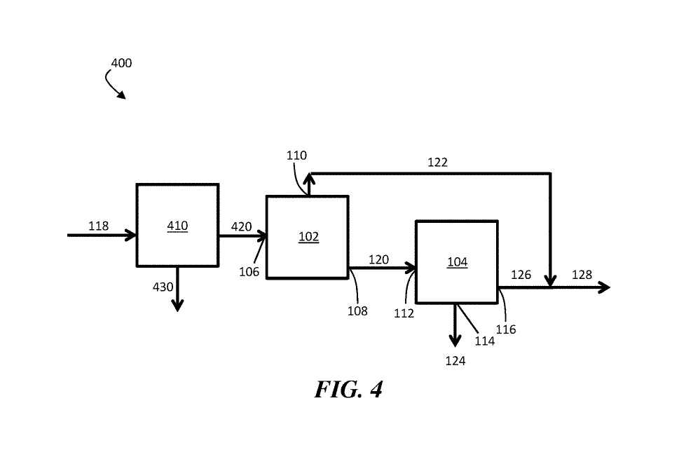

FIG. 4 is an exemplary schematic illustration of a system 400 in which water-immiscible separator 410 is configured to remove at least a portion of a suspended and/or emulsified immiscible phase from aqueous feed stream 118 before the aqueous feed stream is transported to ion-selective separator 102. As shown in FIG. 4, water-immiscible phase separator 410 is configured to produce immiscible-phase-diminished stream 420 and immiscible-phase-enriched stream 430. Immiscible-phase-diminished stream 420 may be directed to flow to ion-selective separator 102, which is fluidically connected to desalination apparatus 104. Immiscible-phase-enriched stream 430 may be discharged from system 400.

In certain embodiments, the water-immiscible phase separator is configured to remove a relatively large percentage of water-immiscible material from the aqueous feed stream. For example, in some embodiments, the amount (in weight percentage, wt %) of at least one water-immiscible material within the immiscible-phase-diminished stream exiting the water-immiscible phase separator is at least about 50%, at least about 75%, at least about 90%, at least about 95%, or at least about 99% less than the amount of the at least one water-immiscible material within the stream entering the water-immiscible phase separator. To illustrate, if the stream exiting the water-immiscible phase separator contains 5 wt % water-immiscible material, and the stream entering the water-immiscible phase separator contains 50 wt % water-immiscible material, then the stream exiting the water-immiscible phase separator contains 90% less water-immiscible than the stream entering the water-immiscible phase separator. In certain embodiments, the sum of the amounts of all water-immiscible materials within the stream exiting the water-immiscible phase separator is at least about 50%, at least about 75%, at least about 90%, at least about 95%, or at least about 99% less than the sum of the amounts of all water-immiscible materials within the stream entering the water-immiscible phase separator.

In certain embodiments, the water-immiscible phase separator can be configured to output an immiscible-phase-diminished stream having a concentration of suspended and/or emulsified immiscible phase(s) of less than about 10 ppm, less than about 1 ppm, or less than about 0.1 ppm. In certain embodiments, the water-immiscible phase separator can be configured to output an immiscible-phase-diminished (e.g., to an ion-selective membrane and/or an ion-selective membrane separator) having a concentration of oil of less than about 10 ppm, less than about 1 ppm, or less than about 0.1 ppm.

While the water-immiscible phase separator can be used to separate a suspended and/or emulsified immiscible phase from an incoming aqueous feed stream, such separation is optional. For example, in some embodiments, the aqueous feed stream transported to the system is substantially free of a suspended and/or emulsified immiscible phase, or it contains an amount of suspended and/or emulsified immiscible phase that is sufficiently low that acceptable operation of the system can be obtained without using a water-immiscible phase separator.

A variety of water-immiscible phase separators are suitable for use according to certain of the embodiments described herein. In some embodiments, the water-immiscible phase separator at least partially separates the immiscible phase from the aqueous feed stream via gravity, centrifugal force, adsorption, and/or a physical barrier. In some embodiments, the water-immiscible phase separator comprises a hydrocyclone, such as a de-oiling hydrocyclone. In some embodiments, the hydrocyclone can be configured to remove droplets of the immiscible phase having a diameter of greater than about 10 micrometers. In certain embodiments, the water-immiscible phase separator comprises a corrugated plate interceptor. In some embodiments, the corrugated plate interceptor can be configured to remove droplets of the immiscible phase having a diameter of greater than about 50 micrometers. In some embodiments, the water-immiscible phase separator comprises an adsorption media filter. The adsorption media filter can contain an adsorption medium. The adsorption medium may comprise, for example, walnut shells. In some embodiments, the adsorption media filter can be configured to remove droplets of the immiscible phase having a diameter of greater than about 150 micrometers. The water-immiscible phase separator comprises, according to certain embodiments, a coalescing media filter. The coalescing media filter can be configured, in some embodiments, to remove droplets of the immiscible phase having a diameter of less than about 2 micrometers. In some embodiments, the water-immiscible phase separator comprises a membrane filter. In certain embodiments, the membrane filter can be configured to remove droplets of the immiscible phase having a diameter of less than about 1 micrometer. In certain embodiments, the water-immiscible phase separator comprises a settling zone in which water and the immiscible phase are at least partially physically separated. The settling zone may comprise, for example, a crystallization tank (which can be, in some embodiments, a settling tank). As one example, the water-immiscible phase separator may comprise, according to certain embodiments, an American Petroleum Institute separator, commonly referred to as API separators. In some embodiments, the API separator can be configured to remove droplets of the immiscible phase having a diameter of greater than about 150 micrometers. According to some embodiments, the water-immiscible phase separator comprises a skimmer. In some embodiments, the water-immiscible phase separator comprises a dissolved gas floatation (DGF) apparatus. In certain embodiments, the water-immiscible phase separator comprises an induced gas flotation (IGF) apparatus. In some embodiments, the DGF and/or IGF apparatus can be configured to remove droplets of the immiscible phase having a diameter of greater than about 20 micrometers.

In some embodiments, an optional strainer (e.g., a device configured to prevent the passage of particles having a certain size) is positioned upstream of the water-immiscible phase separator. In some embodiments, the strainer is configured to prevent the passage of particles having an average diameter of at least about 0.1 mm, at least about 0.5 mm, at least about 1 mm, at least about 2 mm, at least about 5 mm, at least about 10 mm, at least about 15 mm, or at least about 20 mm. Non-limiting examples of suitable strainers include basket strainers, duplex basket strainers (e.g., twin basket strainers), Y-strainers, T-strainers, inline strainers, automatic self-cleaning strainers, plate strainers (e.g., expanded cross-section strainers), scraper strainers, and/or magnetic strainers.

In some embodiments, the water-immiscible phase separator is fluidically connected to one or more additional water-immiscible phase separators configured to remove at least a portion of a suspended and/or emulsified immiscible phase from an immiscible-phase-enriched stream via gravity, centrifugal force, adsorption, and/or a physical barrier. The one or more additional water-immiscible phase separators may be any type of separator known in the art. In some cases, the one or more additional water-immiscible phase separators comprise a dissolved gas flotation (DGF) separator, a gravity separator (e.g., an API separator), an induced gas flotation (IGF) separator, a hydrocyclone (e.g., a de-oiling hydrocyclone), a corrugated plate interceptor, an adsorption media filter, a coalescing media filter, a membrane filter, and/or a skimmer. The one or more additional water-immiscible separators may be the same type of separator or different types of separators. In some embodiments, the one or more additional water-immiscible phase separators may be arranged in series and/or in parallel.

According to some embodiments, one or more devices configured to remove certain components of an aqueous feed stream may be positioned upstream of the ion-selective separator. For example, in certain embodiments, a suspended solids removal apparatus (e.g., a filter, a gravity settler, a coagulant-induced flocculator) configured to remove at least a portion of suspended solids (e.g., dirt, precipitated salts, organic solids) from a feed stream may be fluidically connected to the ion-selective separator. In some embodiments, a volatile organic material (VOM) removal apparatus (e.g., a carbon bed filter, an air stripper) configured to remove at least a portion of VOM (e.g., organic materials that at least partially evaporate at 25° C. and 1 atmosphere) from a feed stream may be fluidically connected to the ion-selective separator.

Certain embodiments are related to producing multivalent-ion-enriched streams for use in oil recovery. Oil reservoirs generally include porous rocks, the pores of which may contain oil. In some cases, injection of water rich in solubilized multivalent ions can aid in the extraction of oil from such pores. Accordingly, some embodiments comprise injecting a multivalent-ion-enriched product stream (e.g., any of the multivalent-ion-enriched product streams described herein) into a subterranean space. The subterranean space may comprise, for example, oil contained within the pores of a porous material (e.g., porous rocks or other porous materials). In certain embodiments, the subterranean space may be part of an oil well. In certain embodiments, the multivalent-ion-enriched stream that is injected into the subterranean space can be injected under pressure (e.g., under a gauge pressure of at least about 1 bar, at least about 2 bar, at least about 5 bar, at least about 10 bar, at least about 25 bar, or more). Certain embodiments can comprise recovering at least a portion of the monovalent-ion-enriched stream from the subterranean space. In certain embodiments, the aqueous feed stream used in the system (e.g., any of the aqueous feed streams described herein) can comprise at least a portion of the monovalent-ion-enriched stream recovered from the subterranean space.

Various components are described herein as being either directly fluidically connected or indirectly fluidically connected. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least about 50 wt % (or at least about 75 wt %, at least about 90 wt %, at least about 95 wt %, or at least about 98 wt %) of the fluid in the first region is transported to the second region via the direct fluidic connection.

U.S. Provisional Patent Application Ser. No. 62/205,640, filed Aug. 14, 2015 and entitled “Production of Multivalent Ion-Rich Streams Using Humidification-Dehumidification Systems” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
transporting an aqueous feed stream containing solubilized monovalent ions and solubilized multivalent ions into an ion-selective separator comprising an ion-selective membrane to produce a first permeate stream containing at least about 75% of the solubilized monovalent ions from the aqueous feed stream and a first retentate stream containing at least about 75% of the solubilized multivalent ions from the aqueous feed stream;
transporting at least a portion of the first permeate stream to a desalination apparatus comprising a humidifier and a dehumidifier;
allowing at least a portion of the first permeate stream to evaporate within a humidifier of the desalination apparatus to produce a humidified gas and a concentrated aqueous stream having a higher concentration of solubilized monovalent ions than the first permeate stream;
condensing at least a portion of the water within the humidified gas within the dehumidifier to produce a condensed aqueous stream; and
mixing at least a portion of the condensed aqueous stream with at least a portion of the first retentate stream to form a combined product stream.

2. The method of claim 1, wherein the ion-selective membrane is a nanofiltration membrane.

3. The method of any preceding claim, wherein the humidifier is a bubble column humidifier.

4. The method of any preceding claim, wherein the humidifier is a packed bed humidifier.

5. The method of any preceding claim, wherein the dehumidifier is a bubble column dehumidifier.

6. The method of any preceding claim, wherein the desalination apparatus comprises a plurality of desalination units.

7. The method of any preceding claim, wherein at least a portion of the plurality of desalination units are arranged in series.

8. The method of any preceding claim, wherein at least a portion of the plurality of desalination units are arranged in parallel.

9. The method of any preceding claim, wherein the solubilized monovalent ions comprise sodium ions and/or chloride ions.

10. The method of any preceding claim, wherein the solubilized multivalent ions comprise calcium ions, magnesium ions, and/or sulfate ions.

11. The method of any preceding claim, wherein the combined product stream contains at least about 75% of the solubilized multivalent ions from the aqueous feed stream.

12. The method of any preceding claim, wherein the combined product stream contains at least about 90% of the solubilized multivalent ions from the aqueous feed stream.

13. The method of any preceding claim, wherein the combined product stream has a total solubilized multivalent ion concentration of at least about 5,000 mg/L.

14. The method of any preceding claim, wherein the combined product stream contains about 25% or less of the solubilized monovalent ions from the aqueous feed stream.

15. The method of any preceding claim, wherein the combined product stream contains about 10% or less of the solubilized monovalent ions from the aqueous feed stream.

16. The method of any preceding claim, wherein the combined product stream has a total solubilized monovalent ion concentration of about 5,000 mg/L or less.

17. The method of any preceding claim, further comprising:
providing electrical power from a generator to the ion-selective separator; and
transferring heat from the generator to the desalination apparatus.

18. The method of any preceding claim, further comprising providing electrical power from the generator to the desalination apparatus, wherein the heat transferred from the generator to the desalination apparatus is substantially greater than the electrical power provided from the generator to the desalination apparatus.

19. The method of any preceding claim, further comprising:
recirculating the concentrated aqueous stream through the desalination apparatus to allow at least a portion of the concentrated aqueous stream to evaporate within the humidifier to produce a recirculated concentrated aqueous stream having a higher concentration of solubilized monovalent ions than the concentrated aqueous stream; and
discharging the recirculated concentrated aqueous stream from the desalination apparatus when the recirculated concentrated aqueous stream reaches a density of at least about 10 pounds per gallon.

20. The method of any preceding claim, further comprising adding a salt to the recirculated concentrated aqueous stream until the recirculated concentrated aqueous stream reaches a density of at least about 11.7 pounds per gallon.

21. The method of any preceding claim, further comprising flowing the aqueous feed stream through a water-immiscible phase separator to remove at least a portion of a suspended and/or emulsified immiscible phase from the aqueous feed stream prior to supplying the aqueous feed stream to the ion-selective separator.

22. The method of any preceding claim, wherein the suspended and/or emulsified immiscible phase comprises oil and/or grease.

23. The method of any preceding claim, further comprising flowing the concentrated aqueous stream or recirculated concentrated aqueous stream through a heat exchanger.

24. A system, comprising:
an ion-selective separator comprising an ion-selective membrane, the separator comprising a retentate side and a permeate side; and
a humidification-dehumidification desalination apparatus, wherein the desalination apparatus is fluidically connected to the permeate side of the ion-selective separator, wherein the desalination apparatus is fluidically connected to the retentate side of the ion-selective separator.

25. The system of any preceding claim, wherein the ion-selective membrane is a nanofiltration membrane.

26. The system of any preceding claim, wherein the humidification-dehumidification desalination apparatus comprises a humidifier and a dehumidifier, wherein the humidifier is fluidically connected to the permeate side of the ion-selective separator, wherein the dehumidifier is fluidically connected to the humidifier and to the retentate side of the ion-selective separator.

27. The system of any preceding claim, wherein the humidifier and the dehumidifier are housed within a single vessel.

28. The system of any preceding claim, wherein the humidifier and the dehumidifier are housed within separate vessels.

29. The system of any preceding claim, wherein the humidifier is a bubble column humidifier.

30. The system of any preceding claim, wherein the humidifier is a packed bed humidifier.

31. The system of any preceding claim, wherein the dehumidifier is a bubble column dehumidifier.

32. The system of any preceding claim, where the desalination apparatus comprises a plurality of desalination units, wherein at least a portion of the plurality of desalination units are arranged in series.

33. The system of any preceding claim, where the desalination apparatus comprises a plurality of desalination units, wherein at least a portion of the plurality of desalination units are arranged in parallel.

34. The system of any preceding claim, further comprising a generator in electrical communication with the ion-selective separator and in electrical communication and/or thermal communication with the desalination apparatus.

35. The system of any preceding claim, further comprising a water-immiscible phase separator fluidly connected to the ion-selective separator and configured to remove at least a portion of a suspended and/or emulsified immiscible phase from the aqueous feed stream.

36. The system of any preceding claim, further comprising a heat exchanger fluidically connected to the desalination apparatus.

37. The system of any preceding claim, wherein the heat exchanger is a counter-flow heat exchanger.
